(19) United States
(12) Patent Application Publication
(10) Pub. No.: US 2026/0239036 A1
(43) Pub. Date: Aug. 13, 2026

(54) PARAMETER UPDATES FOR ULTRA-HIGH RELIABILITY OPERATION MODES

(71) Applicant: QUALCOMM Incorporated, San Diego, CA (US)

(72) Inventors: Gaurang NAIK, San Diego, CA (US); Alfred ASTERJADHI, San Diego, CA (US); Abhishek Pramod PATIL, San Diego, CA (US); George CHERIAN, San Diego, CA (US); Sai Yiu Duncan HO, San Diego, CA (US); Sherief HELWA, San Diego, CA (US); Sanket Sanjay KALAMKAR, San Diego, CA (US); Giovanni CHISCI, San Diego, CA (US)

(21) Appl. No.: 19/534,626

(22) Filed: Feb. 9, 2026

Related U.S. Application Data
(60) Provisional application No. 63/757,228, filed on Feb. 11, 2025.

(51) Int. Cl. H04W 24/02

(52) U.S. Cl. CPC H04W 24/02

(57) ABSTRACT

This disclosure provides methods, components, devices and systems for parameter updates for ultra-high reliability (UHR) operation modes. Some aspects more specifically relate to signaling mechanisms according to which an access point (AP) may provide an indication of current and future states or parameter sets associated with one or more operation modes. In some examples, the AP may transmit a management frame that includes information indicative of the current and future states or parameter sets associated with one or more operation modes. Some additional, or alternative, aspects more specifically relate to signaling mechanisms according to which a station (STA) may request one or more states or one or more parameter sets associated with one or more operation modes. For example, the STA may request that one or more operation modes be enabled or disabled or may request one or more specific parameters associated with one or more operation modes.

### CROSS REFERENCE

The present Application for Patent claims the benefit of U.S. Provisional Patent Application No. 63/757,228 by NAIK et al., entitled “PARAMETER UPDATES FOR ULTRA-HIGH RELIABILITY OPERATION MODES,” filed Feb. 11, 2025, assigned to the assignee hereof, and which is expressly incorporated by reference in its entirety herein.

### TECHNICAL FIELD

This disclosure relates generally to wireless communication and, more specifically, to parameter updates for ultra-high reliability (UHR) operation modes.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication networks face challenges related to operation mode parameter management and signaling efficiency. While APs can broadcast information indicating states and parameter sets associated with various operation modes, some signaling protocols expect associated STAs to comply with any state or parameter updates shortly after receiving such information. This expectation of immediate compliance may incur relatively high processing and configuration costs at the associated STAs. Additionally, such reliance on prompt adjustment to indicated updates may result in reliability issues arising from communication failures or non-compliance, particularly when a STA is unable to promptly adjust to one or more indicated state or parameter updates. These challenges can negatively impact overall network performance, communication reliability, and operational efficiency.

### SUMMARY

The systems, methods, and devices of this disclosure each have several aspects, no single one of which is solely responsible for the desirable attributes disclosed herein.

One aspect can be implemented as a method for wireless communication by an access point (AP). The method includes transmitting, to one or more stations (STAs), a management frame that includes first information that indicates a set of current states associated with a set of operation modes and second information that indicates at least one future state associated with at least one operation mode of the set of operation modes; and communicating one or more messages with at least one STA of the one or more STAs in accordance with the first information within a first time period and in accordance with the second information within a second time period subsequent to the first time period.

Another aspect can be implemented in an AP that includes a processing system with processor circuitry and memory circuitry that stores code. The processing system is configured to cause the AP to transmit, to one or more STAs, a management frame that includes first information that indicates a set of current states associated with a set of operation modes and second information that indicates at least one future state associated with at least one operation mode of the set of operation modes; and to communicate one or more messages with at least one STA in accordance with the first information within a first time period and in accordance with the second information within a second time period subsequent to the first time period.

Another aspect can be implemented in an AP that includes at least one means for wireless communication. The AP includes means for transmitting, to one or more STAs, a management frame that includes first information that indicates a set of current states associated with a set of operation modes and second information that indicates at least one future state associated with at least one operation mode of the set of operation modes; and means for communicating one or more messages with at least one STA in accordance with the first information within a first time period and in accordance with the second information within a second time period subsequent to the first time period.

Another aspect can be implemented in a non-transitory computer-readable medium storing code for wireless communication. The code includes instructions executable by one or more processors to cause an AP to transmit, to one or more STAs, a management frame that includes first information that indicates a set of current states associated with a set of operation modes and second information that indicates at least one future state associated with at least one operation mode of the set of operation modes; and to communicate one or more messages with at least one STA in accordance with the first information within a first time period and in accordance with the second information within a second time period subsequent to the first time period.

Another aspect can be implemented as a method for wireless communication by a STA. The method includes receiving, from an AP, a management frame that includes first information that indicates a set of current states associated with a set of operation modes and second information that indicates at least one future state associated with at least one operation mode of the set of operation modes; and communicating one or more messages with the AP in accordance with the first information within a first time period and in accordance with the second information within a second time period subsequent to the first time period.

Another aspect can be implemented in a STA that includes a processing system with processor circuitry and memory circuitry that stores code. The processing system is configured to cause the STA to receive, from an AP, a management frame that includes first information that indicates a set of current states associated with a set of operation modes and second information that indicates at least one future state associated with at least one operation mode of the set of operation modes; and to communicate one or more messages with the AP in accordance with the first information within a first time period and in accordance with the second information within a second time period subsequent to the first time period.

Another aspect can be implemented in a STA that includes at least one means for wireless communication. The STA includes means for receiving, from an AP, a management frame that includes first information that indicates a set of current states associated with a set of operation modes and second information that indicates at least one future state associated with at least one operation mode of the set of operation modes; and means for communicating one or more messages with the AP in accordance with the first information within a first time period and in accordance with the second information within a second time period subsequent to the first time period.

Another aspect can be implemented in a non-transitory computer-readable medium storing code for wireless communication. The code includes instructions executable by one or more processors to cause a STA to receive, from an AP, a management frame that includes first information that indicates a set of current states associated with a set of operation modes and second information that indicates at least one future state associated with at least one operation mode of the set of operation modes; and to communicate one or more messages with the AP in accordance with the first information within a first time period and in accordance with the second information within a second time period subsequent to the first time period.

Another aspect can be implemented as a method for wireless communication by a STA. The method includes transmitting, to an AP, a first frame that includes first information that indicates at least one requested state associated with at least one operation mode of a set of operation modes or indicates one or more requested parameter sets associated with one or more operation modes of the set of operation modes, or both; receiving, from the AP, a second frame that includes second information that indicates at least one of an acceptance or a confirmation of the at least one requested state or the one or more requested parameter sets; and communicating one or more messages with the AP in accordance with at least one of the first information or the second information.

Another aspect can be implemented in a STA that includes a processing system with processor circuitry and memory circuitry that stores code. The processing system is configured to cause the STA to transmit, to an AP, a first frame that includes first information that indicates at least one requested state associated with at least one operation mode of a set of operation modes or indicates one or more requested parameter sets associated with one or more operation modes of the set of operation modes, or both; to receive, from the AP, a second frame that includes second information that indicates at least one of an acceptance or a confirmation of the at least one requested state or the one or more requested parameter sets; and to communicate one or more messages with the AP in accordance with at least one of the first information or the second information.

Another aspect can be implemented in a STA that includes at least one means for wireless communication. The STA includes means for transmitting, to an AP, a first frame that includes first information that indicates at least one requested state associated with at least one operation mode of a set of operation modes or indicates one or more requested parameter sets associated with one or more operation modes of the set of operation modes, or both; means for receiving, from the AP, a second frame that includes second information that indicates at least one of an acceptance or a confirmation of the at least one requested state or the one or more requested parameter sets; and means for communicating one or more messages with the AP in accordance with at least one of the first information or the second information.

Another aspect can be implemented in a non-transitory computer-readable medium storing code for wireless communication. The code includes instructions executable by one or more processors to cause a STA to transmit, to an AP, a first frame that includes first information that indicates at least one requested state associated with at least one operation mode of a set of operation modes or indicates one or more requested parameter sets associated with one or more operation modes of the set of operation modes, or both; to receive, from the AP, a second frame that includes second information that indicates at least one of an acceptance or a confirmation of the at least one requested state or the one or more requested parameter sets; and to communicate one or more messages with the AP in accordance with at least one of the first information or the second information.

Another aspect can be implemented as a method for wireless communication by an AP. The method includes receiving, from a STA, a first frame that includes first information that indicates at least one requested state associated with at least one operation mode of a set of operation modes or indicates one or more requested parameter sets associated with one or more operation modes of the set of operation modes, or both; transmitting, to the STA, a second frame that includes second information that indicates at least one of an acceptance or a confirmation of the at least one requested state or the one or more requested parameter sets; and communicating one or more messages with the STA in accordance with at least one of the first information or the second information.

Another aspect can be implemented in an AP that includes a processing system with processor circuitry and memory circuitry that stores code. The processing system is configured to cause the AP to receive, from a STA, a first frame that includes first information that indicates at least one requested state associated with at least one operation mode of a set of operation modes or indicates one or more requested parameter sets associated with one or more operation modes of the set of operation modes, or both; to transmit, to the STA, a second frame that includes second information that indicates at least one of an acceptance or a confirmation of the at least one requested state or the one or more requested parameter sets; and to communicate one or more messages with the STA in accordance with at least one of the first information or the second information.

Another aspect can be implemented in an AP that includes at least one means for wireless communication. The AP includes means for receiving, from a STA, a first frame that includes first information that indicates at least one requested state associated with at least one operation mode of a set of operation modes or indicates one or more requested parameter sets associated with one or more operation modes of the set of operation modes, or both; means for transmitting, to the STA, a second frame that includes second information that indicates at least one of an acceptance or a confirmation of the at least one requested state or the one or more requested parameter sets; and means for communicating one or more messages with the STA in accordance with at least one of the first information or the second information.

Another aspect can be implemented in a non-transitory computer-readable medium storing code for wireless communication. The code includes instructions executable by one or more processors to cause an AP to receive, from a STA, a first frame that includes first information that indicates at least one requested state associated with at least one operation mode of a set of operation modes or indicates one or more requested parameter sets associated with one or more operation modes of the set of operation modes, or both; to transmit, to the STA, a second frame that includes second information that indicates at least one of an acceptance or a confirmation of the at least one requested state or the one or more requested parameter sets; and to communicate one or more messages with the STA in accordance with at least one of the first information or the second information.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIGS. 2 and 3 show example signaling diagrams that support parameter updates for ultra-high reliability (UHR) operation modes.

FIG. 4 shows an example UHR operation element that supports parameter updates for UHR operation modes.

FIGS. 5 and 6 show example parameter update elements that support parameter updates for UHR operation modes.

FIGS. 7-10 show example frame formats that support parameter updates for UHR operation modes.

FIG. 11 shows a block diagram of an example wireless communication device that supports parameter updates for UHR operation modes.

FIG. 12 shows a block diagram of an example wireless communication device that supports parameter updates for UHR operation modes.

FIG. 13 shows a flowchart illustrating an example process performable by or at an access point (AP) that supports parameter updates for UHR operation modes.

FIGS. 14 and 15 show flowcharts illustrating example processes performable by or at a station (STA) that supports parameter updates for UHR operation modes.

FIG. 16 shows a flowchart illustrating an example process performable by or at an AP that supports parameter updates for UHR operation modes.

Like reference numbers and designations in the various drawings indicate like elements.

### DETAILED DESCRIPTION

The following description is directed to some particular examples for the purposes of describing aspects of this disclosure. However, a person having ordinary skill in the art will readily recognize that the teachings herein can be applied in a multitude of different ways. Some or all of the described examples may be implemented in a device, component or system that is capable of transmitting and receiving radio frequency (RF) signals according to one or more of the Institute of Electrical and Electronics Engineers (IEEE) 802.11 standards, the IEEE 802.15 standards, the Bluetooth® standards (such as defined by the Bluetooth Special Interest Group (SIG)), or standards promulgated by the 3rd Generation Partnership Project (3GPP) (such as 5G (New Radio (NR)) or 6G), among others. In some examples, such a device, component or system may operate in one or more of a wireless personal area network (WPAN), a wireless local area network (WLAN), a wireless wide area network (WWAN), a wireless metropolitan area network (WMAN), a non-terrestrial network (NTN), or an internet of things (IOT) network, and may be configured to utilize one or more of the following technologies or techniques: code division multiple access (CDMA), time division multiple access (TDMA), orthogonal frequency division multiplexing (OFDM), frequency division multiple access (FDMA), orthogonal FDMA (OFDMA), cyclic prefix-OFDM (CP-OFDM), discrete Fourier transform spread spectrum OFDM (DFT-s-OFDM), filtered OFDM (F-OFDM), single-carrier FDMA (SC-FDMA), spatial division multiple access (SDMA), rate-splitting multiple access (RSMA), multi-user shared access (MUSA), On/Off keying (OOK), Ultra wideband (UWB), universal filtered multi-carrier (UFMC), single-user (SU) multiple-input multiple-output (MIMO) and multi-user (MU)-MIMO (MU-MIMO).

In some wireless communication networks, a wireless communication device may communicate or otherwise operate in accordance with one or more of various operation modes. Example operation modes may include at least one of non-primary channel access (NPCA), dynamic sub-band operation (DSO), dynamic power save (DPS), access point (AP) power save (AP PS), dynamic bandwidth extension (DBE), dynamic unavailability operation (DUO), prioritized enhanced distributed channel access (P-EDCA), or high-priority EDCA (HiP EDCA), among other examples. Such operation modes may be associated with an ultra-high reliability (UHR) amendment or version of the IEEE 802.11 standards and may be referred to herein as UHR operation modes. Each operation mode may be associated with a respective parameter set, with each respective parameter set including one or more parameters that define one or more aspects associated with a corresponding operation mode. For example, an NPCA mode may be associated with (such as defined by) a first parameter set including one or more NPCA-related parameters and a DSO mode may be associated with (such as defined by) a second parameter set including one or more DSO-related parameters. Further, each operation mode may be associated with a respective state, with each respective state indicating whether a corresponding operation mode is currently enabled (such as being or allowed to be used) or disabled (such as not being or not allowed to be used).

An AP may transmit (such as broadcast) information that indicates at least one of a respective state or a respective parameter set associated with each of one or more operation modes supported by the AP. An associated station (STA) may receive the information and identify which operation modes (and which corresponding parameters) are currently being used or allowed to be used in a basic service set (BSS) of the AP. Although broadcasting such information may inform associated STAs of currently enabled/disabled operation modes and the parameters associated with the currently enabled operation modes, such a signaling protocol may rely on or expect the associated STAs to comply with any state/parameter updates shortly (such as approximately immediately) after receiving the information. Such a reliance or expectation may incur relatively high processing/configuration costs at the associated STAs. Additionally, or alternatively, such a reliance or expectation may result in reliability issues arising from communication failures or non-compliance, such as when an associated STA is unable to promptly adjust to one or more indicated state/parameter updates. Thus, some networks may benefit from an advance notification of an update to one or more states or parameter sets associated with one or more operation modes, such as a notification of one or more future states or one or more future parameter sets associated with one or more operation modes that will become effective sometime in the future.

Various aspects relate generally to parameter updates for one or more operation modes, such as UHR operation modes. Some aspects more specifically relate to signaling mechanisms according to which an AP may provide an indication of both current and future states or parameter sets associated with one or more operation modes. The current states or parameter sets may already be effective at a time of the indication or may be effective approximately immediately after the indication (or otherwise within a threshold duration of the indication). The future states or parameter sets may be effective at a future time at least a threshold duration after the indication (such as at least one beacon interval after the indication, among other examples). In some examples, the AP may transmit a management frame that includes information indicative of both the current and future states or parameter sets associated with one or more operation modes. Such information may include first information that indicates a set of current states associated with a set of operation modes or indicates one or more current parameter sets associated with one or more first operation modes of the set of operation modes, or both. Such information may further include second information that indicates a set of future states associated with the set of operation modes or indicates one or more future parameter sets associated with one or more second operation modes of the set of operation modes, or both. The one or more first operation modes may be the same as or different from the one or more second operation modes.

In accordance with providing the first information indicative of the current states or parameter sets and the second information indicative of the future states or parameter sets via a management frame, the AP may efficiently signal (such as broadcast) any updates associated with at least one operation mode to one or more associated STAs. Further, and more specifically by providing the second information indicative of the future states or parameter sets via the management frame, the AP may enable the one or more STAs to anticipate and prepare for the indicated updates, which may allow or facilitate the one or more STAs to respond accordingly (either by complying with the indicated updates or by requesting the AP to use an enabled operation mode). Such efficient signaling and such an enablement of STAs to anticipate and prepare for indicated updates may support reduced complexity and greater communication reliability within the BSS operated by the AP, which may in turn support more efficient power consumption, higher data rates, and greater spectral efficiency, among other benefits.

Some additional, or alternative, aspects more specifically relate to signaling mechanisms according to which a STA may request one or more states or one or more parameter sets, or both, associated with one or more operation modes. For example, the STA may request that one or more operation modes be enabled or disabled or may request one or more specific parameters associated with one or more operation modes, or both. In such examples, the STA may transmit first information that indicates a set of requested states associated with a set of operation modes or indicates one or more requested parameter sets associated with one or more operation modes of the set of operation modes, or both. The one or more operation modes for which the STA requests one or more specific parameters may include one or more operation modes that the STA requests to be enabled or that are already enabled. In examples in which the STA requests that one or more operation modes be disabled, the one or more operation modes requested by the STA to be disabled may include (and may be limited to) one or more operation modes that are already (such as currently) enabled. The STA may transmit the first information to an AP, and the AP may respond by transmitting second information that indicates at least one of an acceptance, a confirmation, a notification, a rejection, or a negotiation of at least one of the set of requested states or the one or more requested parameter sets. In some aspects, the AP may respond with a confirmation or a notification in scenarios in which the AP is not allowed to reject a requested state or parameter. In association with receiving the response from the AP, the STA may communicate with the AP in accordance with at least one of the first information or the second information. For example, the STA may communicate in accordance with the first information, accounting for any changes to the first information indicated by the second information.

In accordance with requesting one or more states or parameter sets associated with one or more operation modes, the STA may achieve greater coordination or collaboration with the AP, which may enable the STA to achieve greater performance or more suitably (such as dynamically) adapt to a specific scenario experienced by the STA. For example, the STA may selectively or conditionally request to operate in accordance with one or more operation modes or may selectively or conditionally request to use one or more STA-specific parameters associated with one or more operation modes in accordance with a STA-specific decision, criterion, or condition, among other examples. By selectively or conditionally requesting one or more states or parameter sets associated with one or more operation modes to more suitably adapt to a specific scenario, the STA may achieve greater communication reliability within the BSS operated by the AP, which may in turn support more efficient power consumption, higher data rates, and greater spectral efficiency, among other benefits.

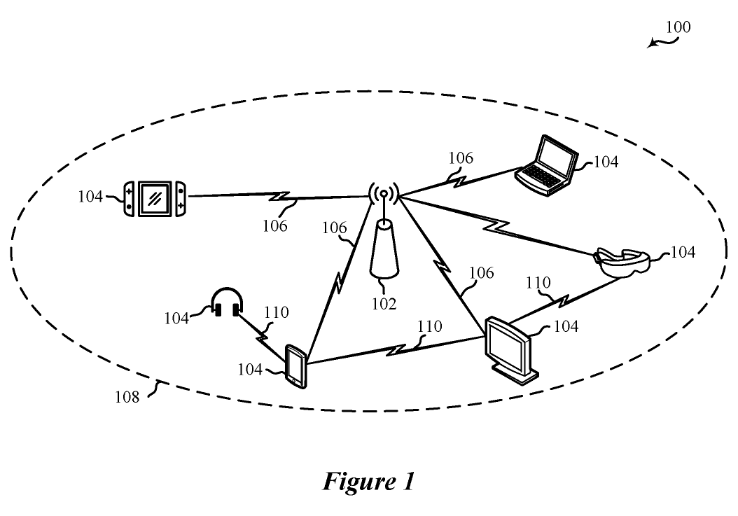

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by one or more of the IEEE 802.11-2020, 802.11-2024, 802.11REVme, 802.11REVmf, or other IEEE 802.11 specifications or amendments thereof (including, but not limited to, 802.11ba, 802.11bc, 802.11bd, 802.11be (also referred to as Wi-Fi 7), 802.11bf, 802.11bh, 802.11bi, 802.11bk, 802.11bn (also referred to as Wi-Fi 8), 802.11bp (also referred to as Ambient Power Communications (AMP)), and 802.11bq (also referred to as Integrated Millimeter Wave (IMMW))). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network’s core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4–1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may select a single primary 20 MHz channel on which the AP 102 and the STAs 104 in its BSS monitor for contention-based access schemes. In some examples, the AP 102 or the STAs 104 may be capable of monitoring a single primary 20 MHz channel for packet detection (such as for detecting preambles of PPDUs). Any transmission by an AP 102 or a STA 104 within a BSS may involve transmission on the primary 20 MHz channel. As such, in some systems, the transmitting device may contend on and win a transmit opportunity (TXOP) on the primary channel to transmit anything at all. However, some APs 102 and STAs 104 supporting UHR communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting (only) legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4x80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160 + 80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields).

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is, in some aspects, a multi-user version of OFDM.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on (only) one communication link at any given time, having access opportunities via two different links enables the MLD to avoid congestion, reduce latency, and maintain throughput.

An MLD that is capable of simultaneous transmission and reception on multiple communication links may be referred to as a simultaneous transmission and reception (STR) device. In an STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered an STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices, and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLO may increase the quantity of users per multiplexed transmission served by the multi-link AP MLD, among other examples.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤ 24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (such as packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In some networks, such as Wi-Fi networks, each 802.11 amendment may define an “operation element” that is applicable for a set of (such as all) STAs 104 within a BSS of an AP 102 that implement (such as support) that amendment. For example, wireless communication devices that support the EHT amendment to the 802.11 standards may support an EHT operation element and wireless communication devices that support the UHR amendment to the 802.11 standards may support a UHR operation element, among other examples. The UHR operation element may be present within one or more select frames (such as beacon frames and probe response frames, among other examples) and may be transmitted by an AP 102, such as a UHR AP. In some networks, STAs 104 (such as UHR non-AP STAs) may not transmit a UHR operation element. The UHR operation element may carry (such as include, provide, or indicate) one or more operation parameters currently being used by (and parameters/modes enforced upon the UHR non-AP STAs associated with) the transmitting AP 102 in the BSS of the AP 102. Additionally, some frames that an AP 102 or a STA 104 transmit or receive may include a multi-link element, which may define one or more parameters associated with an MLO mode.

One or more of the wireless communication devices of the wireless communication network 100 may communicate or otherwise operate in accordance with one or more of various operation modes. Which one or more operation modes a wireless communication device supports may depend on a generation of the wireless communication device, which may pertain to or otherwise be associated with a capability of the wireless communication device. A generation may refer to a specific set of capabilities or features. Different generations of devices may support different sets of operation modes. For example, a first generation of devices may support a first set of operation modes and a second generation of devices may support a second set of operation modes. By way of further example, in an 802.11-compliant Wi-Fi network, such a first generation may be associated with an EHT capability (such as the EHT version or amendment of the 802.11 standard specifications, such as 802.11be) and the first set of operation modes may be associated with the EHT capability, and such a second generation may be associated with a UHR capability (such as the UHR version or amendment of the 802.11 standard specifications, such as 802.11bn) and the second set of operation modes may be associated with the UHR capability. In such examples, the first set of operation modes may be different from the second set of operation modes, with each set of operation modes defined as being associated with (such as introduced in) a respective generation (such as EHT or UHR). The second set of operation modes may be one or more operation modes introduced by the UHR (802.11bn) version of the 802.11 standard specifications.

In examples in which the wireless communication network 100 supports or is otherwise associated with the UHR version or amendment of the IEEE 802.11 standard, which may be referred to herein as the 802.11bn standard amendment, one or more of the wireless communication devices of the wireless communication network 100 may support one or more of various UHR-specific operation modes. Such UHR-specific operation modes, each of which may define or be associated with a respective mode of operation for UHR wireless communication devices, may include an NPCA mode, a DSO mode, a DPS mode (which, in some contexts, may be understood as an AP PS mode), a DBE mode, or a P-EDCA mode (which, in some contexts, may be understood as a HiP-EDCA mode), among other examples. In some implementations, one or more of such operation modes may be enabled or disabled by an AP 102. For example, an AP 102 may periodically or dynamically enable or disable one or more operation modes within a BSS operated, supported, or provided by the AP 102. A state associated with an operation mode may define or indicate whether the operation mode is enabled or disabled. For example, a first state may correspond to a state of “enabled” and a second state may correspond to a state of “disabled.”

An enablement or a disablement of an operation mode by an AP 102 may be associated with a BSS-wide application of the operation mode. In other words, an enablement or a disablement may refer to (such as define or indicate) a BSS-wide application of the operation mode. In examples in which an operation mode is disabled by the AP 102, no STA 104 associated with the AP 102 (nor the AP 102 itself) may operate in the operation mode. Additionally, in some scenarios, no STA 104 that receives an indication of the disablement of the operation mode may operate in the operation (even, for example, if a STA 104 is not associated with the AP 102). In examples in which an operation mode is enabled by the AP 102, a STA 104 associated with the AP 102 may request to enable the operation mode for communication between the STA 104 and the AP 102.

Each operation mode may have one or more associated parameters. For example, each operation mode may be associated with a respective parameter set, with a parameter set including one or more parameters associated with a corresponding operation mode. In other words, a first operation mode may be associated with a first parameter set inclusive of one or more first parameters that define one or more aspects of the first operation mode and a second operation mode may be associated with a second parameter set inclusive of one or more second parameters that define one or more aspects of the second operation mode. Different operation modes are, thus, associated with different parameter sets.

An AP 102 and one or more STAs 104 may exchange signaling indicative of whether one or more operation modes are enabled/disabled (with some operation modes being enabled or some operation modes being disabled, or any combination thereof) and, for each of the operation modes that are enabled, indicative of a respective parameter set. The AP 102 and a STA 104 may exchange such signaling when the AP 102 or the STA 104 enables or disables one or more operation modes or when one or more parameters associated with one or more enabled operation modes are updated (such as relative to one or more previous parameters).

Some networks may expect such signaling to be efficient, extensible, and in accordance with (such as based on) a uniform framework. Further, some networks may support an advance notification for one or more select (such as special or critical) updates. A select update may include an update to at least one parameter associated with an operation mode or an update to a state (such as enabled or disabled) associated with at least one operation mode. With an advance notification for one or more updates, an AP 102 may enable one or more STAs 104 (such as non-AP STAs) to anticipate and prepare for the one or more updates, which may allow or facilitate the STAs 104 to respond accordingly. Additionally, or alternatively, the advance notification may enable two or more APs 102 to coordinate regarding the one or more updates, which may enable two or more coordinating APs 102 to prepare for, or respond to, the one or more updates.

Such networks may define the updates (and related parameters) for which an advance notification is provided and the containers (such as the one or more fields or the one or more elements, or any combination thereof) that carry information indicative of the advance notification. Further, such networks may define how updates are provided depending on (such as in accordance with) whether an update is associated with a reporting link or a reported link. For example, information associated with an update may be provided within a UHR operation element or within a parameter update element, or within both. Additionally, or alternatively, information associated with an update may be provided within a multi-link element, such as a reconfiguration multi-link element, a basic multi-link element, or a special multi-link element that is dedicated for the information associated with the update. In some aspects, updates for a reporting link may be provided within the UHR operation element or within the parameter update element and updates for SMD-level, MLD-level, or cross-link (such as for a reported link) may be provided within one or more multi-link elements.

In some implementations, an AP 102 may provide an advance notification of an update (such as a select update or a future update) on each of a set of links supported or operated by the AP 102. In other words, an AP MLD may provide an advance notification of an update on all links of the AP MLD. For example, if an update is to occur on link 0 of the AP MLD, the AP MLD may provide an advance notification of the update on link 0, link 1, and so on. In some implementations, this may allow an associated STA 104 to learn about the updates by monitoring any link of the AP MLD. In accordance with such multi-link signaling, the signaling associated with advance notifications may be decomposed into or otherwise understood as two components. With regards to a first component, given a specific link, a network may define where and how to carry one or more operational parameters (such as one or more parameter sets) associated with one or more of various operation modes. With regards to a second component, given multiple links, the network may further define where and how to carry one or more operational parameters (such as one or more parameter sets) associated with various links.

Further, although some example signaling diagrams are illustrated and described herein in the example of communication between an AP 102 and a STA 104 (such as a non-AP STA), two or more APs 102 may leverage the illustrated and described signaling diagrams. In other words, the example signaling diagrams illustrated and described herein are also applicable for AP-to-AP communication (such as for coordination of one or more states or one or more parameter sets associated with one or more operation modes between two or more APs 102). For example, in some networks (including UHR networks), APs 102 may support one or more multi-AP coordination (MAPC) schemes according to which two or more APs 102 may coordinate via at least one of a coordinated TDMA mechanism, a coordinated spatial reuse mechanism, a coordinated beamforming mechanism, or a coordinated restricted target wake time (TWT) (r-TWT) mechanism. Each of these mechanisms may be associated with a respective parameter set that APs 102 may exchange (such as signal or communicate, such as via wired or wireless backhaul signaling) with each other. Two or more APs 102 may exchange information that indicates such parameter sets during a negotiation phase or a setup phase, or both.

In scenarios in which at least one parameter changes, or in which a mechanism is (requested) to be enabled or disabled, an AP 102 may transmit an advance notification to one or more other APs 102 indicating the one or more requested/future/updated parameter values or the one or more requested/future/updated states associated with one or more of such mechanisms. For any of such signaling (such as at least one of negotiation phase signaling, setup phase signaling, or advance notification signaling), an AP 102 may transmit information that indicates a set of states associated with a set of mechanisms or indicates one or more parameter sets associated with one or more mechanisms of the set of mechanisms. The AP 102 may transmit such information via one or more of the various elements or frames illustrated and described herein, or one or more elements or frames similar to the one or more of the various elements or frames illustrated and described herein, such as a UHR operation element or a parameter update element, or both, within a frame (such as a management frame). Thus, in some implementations, a UHR operation element or a parameter update element, or any combination of the two, may indicate information associated with one or more of such MAPC schemes or mechanisms (in addition to, or as an alternative to, indicating information associated with one or more (UHR) operation modes).

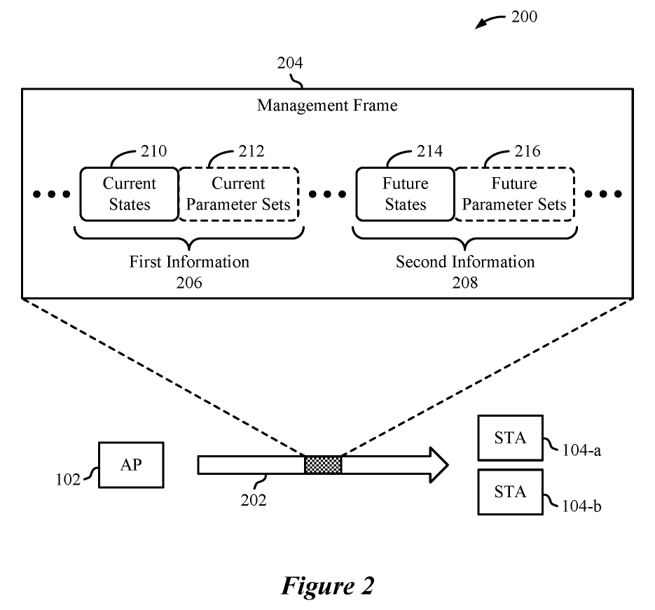

FIG. 2 shows an example signaling diagram 200 that supports parameter updates for ultra-high reliability operation modes. The signaling diagram 200 may implement or be implemented to realize one or more aspects of the wireless communication network 100. For example, the signaling diagram 200 illustrates communication between an AP 102, a STA 104-a, and a STA 104-b, each of which may be an example of corresponding devices illustrated and described herein, including by and with reference to FIG. 1. The AP 102 may transmit (such as broadcast) signaling to the STA 104-a and the STA 104-b via a communication link 202.

In some implementations, the AP 102 may transmit a management frame 204 to at least one of the STA 104-a or the STA 104-b. The management frame 204 may include first information 206 that indicates at least one of a set of current states 210 associated with a set of operation modes, indicates one or more current parameter sets 212 associated with one or more first operation modes of the set of operation modes, or both. Additionally, the management frame 204 may include second information 208 that indicates at least one of a set of future states 214 associated with the set of operation modes, indicates one or more future parameter sets 216 associated with one or more second operation modes of the set of operation modes, or both. The set of operation modes may include at least one of an NPCA mode, a DSO mode, a DBE mode, an AP PS mode, or a HiP EDCA/P-EDCA mode. The one or more first operation modes may include at least one operation mode that is enabled at a current time and the one or more second operation modes may include at least one operation mode that is enabled at a future time. In some implementations, the second information 208 may include an indication of one or more future times at which one or more of the set of future states 214 or the one or more future parameter sets 216 are to be applied. Further, each operation mode may be associated with a respective parameter set that can be modified by the AP 102.

In some examples, the second information 208 may be included only when there is a change in a mode status or a mode parameter. In some of such examples, information for select operation modes may be included within the second information 208. For example, the second information 208 may only include an indication of a state (such as enabled or disabled) and/or one or more parameters for an operation mode if that operation mode has a (state or parameter) change relative to current operation. In some examples, if only a subset of parameters associated with an operation mode is changing, only that subset of parameters may be included in the second information 208 (such that one or more other parameters that are unchanged relative to current operation are not indicated by the second information 208). If there are no planned or expected state or parameter changes for any operation modes (for at least a threshold duration into the future), the second information 208 may be excluded.

For example, an NPCA mode may be associated with an enablement or a disablement by the AP 102 (such as via the first information 206 or the second information 208, or both) and may be associated with a first parameter set including one or more NPCA-related parameters. The one or more NPCA-related parameters that the AP 102 may modify (such as via the first information 206 or the second information 208, or both) may include at least one of a location/channel number of the NPCA primary channel, an NPCA switching delay of the AP 102, an NPCA switch back delay of the AP 102, an NPCA disabled subchannel bitmap, an NPCA minimum (such as lower limit) duration threshold, or whether OBSS NAV information is used during an NPCA switch (which may be a binary indication, such as “0” or “1”), among other examples.

By way of further example, a DSO mode may be associated with an enablement or a disablement by the AP 102 (such as via the first information 206 or the second information 208, or both) and may be associated with a second parameter set including one or more DSO-related parameters. The one or more DSO-related parameters that the AP 102 may modify (such as via the first information 206 or the second information 208, or both) may include at least one of one or more DSO sub-band locations (such as one or more channel numbers or a bitmap indicating the one or more DSO channels), a quantity of spatial streams (such as a number of spatial streams (NSS)) to be used on the one or more DSO sub-bands, or a bandwidth associated with the one or more DSO sub-bands, among other examples.

By way of further example, a DBE mode may be associated with an enablement or a disablement by the AP 102 (such as via the first information 206 or the second information 208, or both) and may be associated with a third parameter set including one or more DBE-related parameters. The one or more DBE-related parameters that the AP 102 may modify (such as via the first information 206 or the second information 208, or both) may include at least one of a bandwidth of the expanded mode, a channel of the expanded mode (such as a channel number), or a duration of the expanded mode (such as in terms of a quantity of beacon intervals, such as a quantity of TBTTs), among other examples.

By way of further example, an AP PS mode may be associated with an enablement or a disablement by the AP 102 (such as via the first information 206 or the second information 208, or both) and may be associated with a fourth parameter set including one or more AP PS-related parameters. The AP 102 may enable or disable the AP PS mode dynamically or in a scheduled manner, such as for both dynamic AP PS and scheduled AP PS. The one or more AP PS-related parameters that the AP 102 may modify (such as via the first information 206 or the second information 208, or both) may include at least one of a padding delay (which may be used for an initial control frame (ICF)), a switch back delay, a switch back mechanism, one or more high-capability mode (HCM) parameters, or one or more low-capability mode (LCM) parameters, among other examples. HCM and LCM parameters may include at least one of a bandwidth, an NSS, a modulation and coding scheme (MCS), or a PPDU format.

By way of further example, a HiP EDCA or P-EDCA mode may be associated with an enablement or a disablement by the AP 102 (such as via the first information 206 or the second information 208, or both) and may be associated with a fifth parameter set including one or more HiP EDCA- or P-EDCA-related parameters. The one or more HiP EDCA- or P-EDCA-related parameters that the AP 102 may modify (such as via the first information 206 or the second information 208, or both) may include at least one of one or more CW values (such as CWₘₐₓ or CWₘᵢₙ for one or more of various ACs) or a quantity of retries, among other examples.

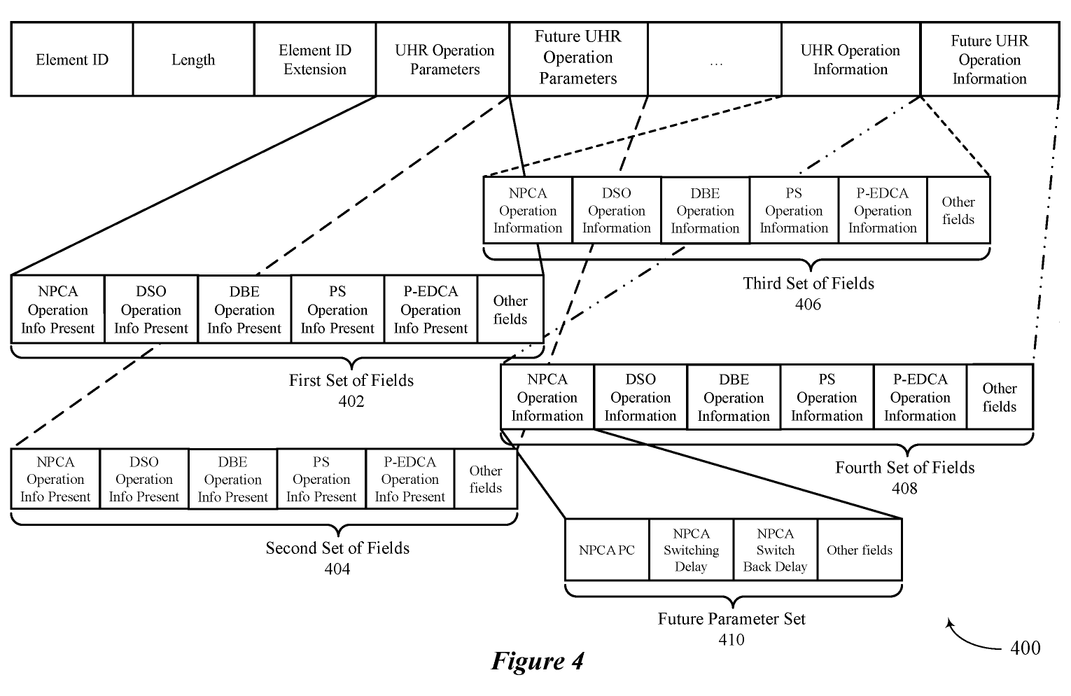

The AP 102 may support a first set of one or more signaling protocols associated with where and how to carry the second information 208 (such as the future operational parameters) given a specific link. According to such a first set of one or more signaling protocols, the AP 102 may provide the first information 206 and the second information 208 in a same element (such as a same UHR operation element) of the management frame 204. Alternatively, the AP 102 may provide the first information 206 in a first element (such as a UHR operation element) of the management frame 204 and may provide the second information 208 in a second element (such as a parameter update element, which may be referred to as a critical update element) of the management frame 204. Additionally, or alternatively, the AP 102 may support a second set of one or more signaling protocols associated with where and how to carry future operational parameters given multiple links. According to such a second set of signaling protocols, the AP 102 may provide the future operational parameters associated with one or more other links (such as reported links) within one or more per-STA profiles of a multi-link element. Additional details related to such signaling protocols, which may be used independently or in any combination, are illustrated by and described with reference to FIGS. 4-10. Each of FIGS. 4-10 illustrate a respective element or frame format, which the AP 102 may use independently or in any combination to provide the first information 206 or the second information 208, or any subset or combination thereof. In other words, the AP 102 may provide the first information 206 or the second information 208, or any portion or combination thereof, via any combination of any one or more fields or elements illustrated by FIGS. 4-10.

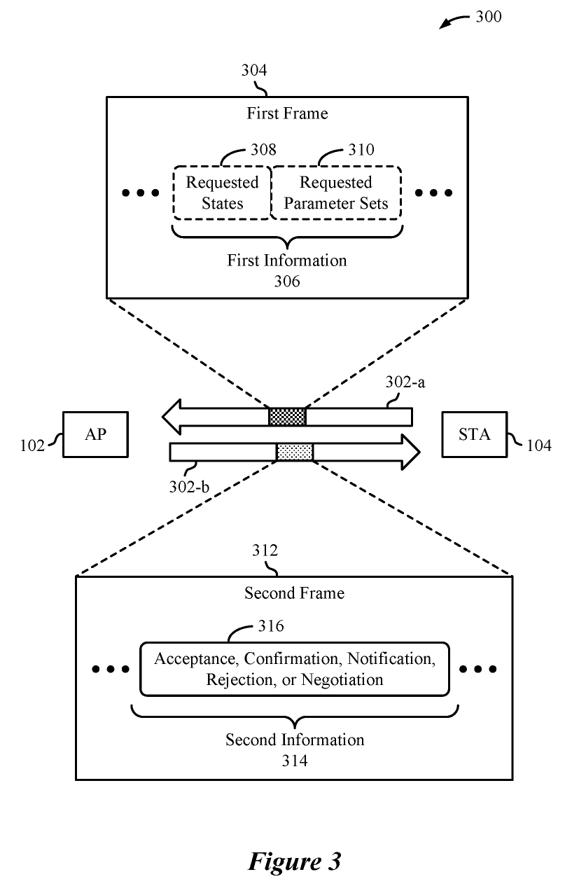

FIG. 3 shows an example signaling diagram 300 that supports parameter updates for ultra-high reliability operation modes. The signaling diagram 300 may implement or be implemented to realize one or more aspects of the wireless communication network 100 or the signaling diagram 200. For example, the signaling diagram 300 illustrates communication between an AP 102 and a STA 104, each of which may be an example of corresponding devices illustrated and described herein, including by and with reference to FIGS. 1 and 2. The STA 104 may transmit signaling to the AP 102 via a communication link 302-a (such as an uplink) and the AP 102 may transmit signaling to the STA 104 via a communication link 302-b (such as a downlink). In some implementations, the signaling that the STA 104 transmits via the communication link 302-a may pertain to one or more operation modes that apply to the communication link 302-b. In other words, the one or more operation modes may be downlink-specific. Additionally, or alternatively, the STA 104 may be affiliated with a non-AP MLD and may transmit signaling via one link that includes information indicative of states/parameter sets associated with one or more operation modes that pertain to one or more other links of the non-AP MLD. In other words, which operation modes are enabled or disabled and the parameter sets associated with enabled operation modes may be link-specific.

In some implementations, the STA 104 may transmit a first frame 304 to the AP 102. The first frame 304 may include first information 306 that indicates a set of requested states 308 associated with a set of operation modes or indicates one or more requested parameter sets 310 associated with one or more operation modes of the set of operation modes, or both. In some examples, the first information 306 may indicate at least one requested state associated with at least one operation mode of the set of operation modes. In some such examples, the at least one operation mode may be a subset of a larger set of operation modes (such that the STA 104 may request a state, of enabled or disabled, for an operation mode of a larger set of operation modes, and may not request states for all operation modes of the larger set of operation modes). In examples in which the first information 306 indicates the set of requested states 308, the information 306 may indicate a requested state for each operation mode of the set of operation modes. The one or more operation modes may include at least one operation mode that the STA 104 requests to be enabled or disabled. The set of operation modes may include at least one of an NPCA mode, a DSO mode, a DBE mode, a DPS mode, or a DUO mode. The STA 104 may be expected to request enablement or disablement and provide or update one or more parameters for one or more of such various operation modes. Each operation mode may be associated with a respective parameter set that can be modified (or requested to be modified) by a non-AP STA (such as the STA 104 of FIG. 3).

For example, an NPCA mode may be associated with an enablement or a disablement by the STA 104 (such as via the first information 306) and may be associated with a first parameter set including one or more NPCA-related parameters. The one or more NPCA-related parameters that the STA 104 may modify or request to be modified (such as via the first information 306) may include at least one of an NPCA switching delay of the STA 104 or an NPCA switch back delay of the STA 104, among other examples.

By way of further example, a DSO mode may be associated with an enablement or a disablement by the STA 104 (such as via the first information 306) and may be associated with a second parameter set including one or more DSO-related parameters. The one or more DSO-related parameters that the STA 104 may modify or request to be modified (such as via the first information 306) may include at least one of one or more DSO sub-band locations (such as one or more channel numbers or a bitmap indicating one or more DSO channels), a quantity of spatial streams (such as an NSS) to be used on the one or more DSO sub-bands, or a bandwidth associated with the one or more DSO sub-bands, among other examples.

By way of further example, a DBE mode may be associated with an enablement or a disablement by the STA 104 (such as via the first information 306) and may be associated with a third parameter set including one or more DBE-related parameters. The one or more DBE-related parameters that the STA 104 may modify or request to be modified (such as via the first information 306) may include at least one of a bandwidth of the expanded mode, a delay for switching from a regular bandwidth mode to the expanded bandwidth mode, or a delay for switching from the expanded bandwidth mode to the regular bandwidth mode, among other examples.

By way of further example, a DPS mode may be associated with an enablement or a disablement by the STA 104 (such as via the first information 306) and may be associated with a fourth parameter set including one or more DPS-related parameters. The one or more DPS-related parameters that the STA 104 may modify or request to be modified (such as via the first information 306) may include at least one of a padding delay (such as used for an ICF), a switch back delay, a switch back mechanism, one or more HCM parameters, or one or more LCM parameters, among other examples. The HCM and LCM parameters may include at least one of a bandwidth, an NSS, an MCS, or a PPDU format.

By way of further example, a DUO mode may be associated with an enablement or a disablement by the STA 104 (such as via the first information 306) and may be associated with a fifth parameter set including one or more DUO-related parameters. The one or more DUO-related parameters that the STA 104 may modify or request to be modified (such as via the first information 306) may include at least one of an unavailability start time, an unavailability duration, a bandwidth (via which the STA 104 is unavailable), a disabled subchannel bitmap (indicating via which subchannels the STA 104 is unavailable), a maximum or upper limit MCS, a PPDU format, or an NSS, among other examples.

In some networks, the STA 104 is not allowed to or may otherwise elect not to transmit some elements, such as a UHR operation element. In such networks, the STA 104 may signal the first information 306 via other elements, such as an element dedicated to carrying the first information 306. Such an element may be a parameter update element. Further, the STA 104 may not provide advance notifications of one or more updates. Instead, when the STA 104 indicates one or more operational parameters to the AP 102, the intention of the STA 104 may be to indicate or provide the operational parameters that the STA 104 intends to use. In other words, the parameters indicated by the one or more requested parameter sets 310 may be understood as current parameters or parameters that the STA 104 intends to use within a threshold time duration of transmitting the first frame 304 or within a threshold time duration after receiving a response to the first frame 304.

In some implementations, an interpretation of a field or element may be different depending on (such as based on or otherwise in accordance with) whether the field or element is transmitted by the AP 102 or the STA 104. In other words, some field or element interpretations may be associated with a type of a device that transmits a frame including the field or element. For example, a timer field (which may be present within one or more fields illustrated or labeled herein as “other fields”) may be interpreted, when transmitted by the STA 104, as a time within which the AP 102 is requested or expected to respond to the request(s) by the STA 104. In other words, the timer field may indicate the time within which the AP 102 is requested or expected to enable a requested operation mode or update an operation mode with one or more requested parameters. In some implementations, if the AP 102 does not enable the requested operation mode within the specified time, the STA 104 may transmit another request to the AP 102 or may consider the operation mode enabled by the AP 102. As another example, the NPCA Operation Info Present subfield, when transmitted by the AP 102, may indicate that the NPCA mode is enabled by the AP 102, whereas when the subfield is transmitted by the STA 104, it may indicate that the mode is requested to be enabled by the STA 104.

The first frame 304 (such as the frame for carrying the operational parameters requested by the STA 104) may be an action frame associated with a link reconfiguration framework, a UHR operation mode notification frame, or a (re)association request frame. A content or format of the first frame 304 may be associated with the type of the first frame 304. For example, the first frame 304 may be associated with a first content or format in implementations in which the first frame 304 is an action frame, a second content or format in implementations in which the first frame 304 is a notification frame, and a third content or format in implementations in which the first frame 304 is a (re)association request frame.

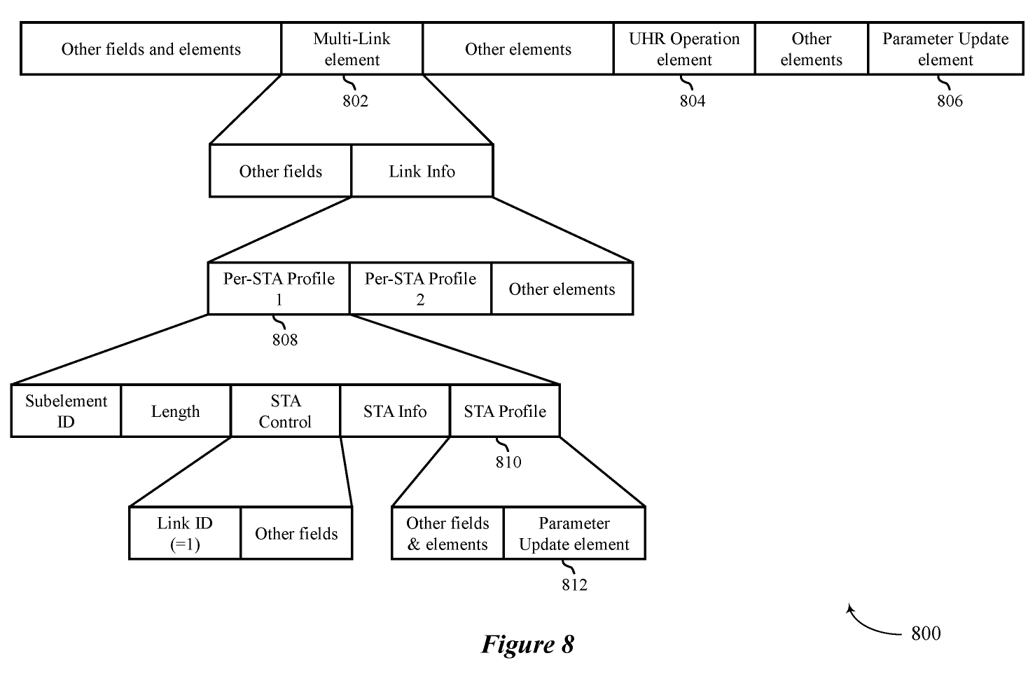

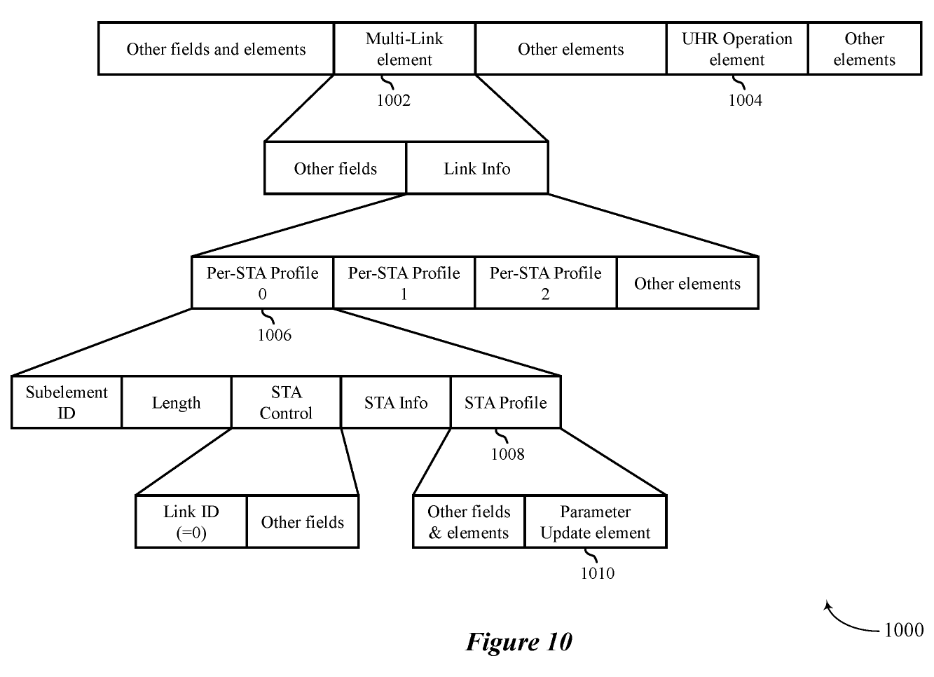

In implementations in which the first frame 304 is an action frame associated with a link reconfiguration framework, the first frame 304 may be a Multi-Link Operation Update Request frame, a Link Reconfiguration Request frame, or another action frame defined in UHR that carries a reconfiguration multi-link element. In some aspects, the STA 104 may transmit the first frame 304 as an action frame in scenarios in which the STA 104 is affiliated with a non-AP MLD. In some aspects, the STA 104 may include a reconfiguration multi-link element to optionally include one or more operational parameters associated with a link via which the first frame 304 is transmitted and optionally for one or more other links established between the non-AP MLD and an AP MLD. For example, the first frame 304 may be associated with a frame format as defined by the frame format 800 or the frame format 1000 as illustrated by FIGS. 8 and 10, respectively, but without a UHR operation element within the first frame 304. In other words, (requested) updates/enablement/disablement for an operation mode associated with a same link may be in a frame body or may be in a per-STA profile within a multi-link element.

In implementations in which the first frame 304 is a UHR operation mode notification frame, the first frame 304 may be a protected UHR action frame. The STA 104 may transmit the first frame 304 as a UHR operation mode notification frame regardless of whether the STA 104 is affiliated with a non-AP MLD. In examples in which the STA 104 is affiliated with a non-AP MLD, the STA 104 may include a multi-link element (such as a reconfiguration, basic, or parameter update variant of a multi-link element) to optionally include one or more operational parameters associated with a link via which the first frame 304 is transmitted as well as one or more other links established between the non-AP MLD and an AP MLD. In such examples, the first frame 304 may be associated with a frame format as defined by the frame format 800 or the frame format 1000 as illustrated by FIGS. 8 and 10, respectively, but without a UHR operation element within the first frame 304. In other words, (requested) updates/enablement/disablement for an operation mode associated with a same link may be in a frame body or may be in a per-STA profile within a multi-link element. In examples in which the STA 104 is not affiliated with a non-AP MLD, the STA 104 may include, within the first frame 304, (only) parameters associated with the link via which the first frame 304 is transmitted. The STA 104 may not include a multi-link element within the first frame 304 and a parameter update element may be present within the frame body.

In implementations in which the first frame 304 is a (re)association request frame, the STA 104 may transmit the first frame 304 as the (re)association request frame regardless of whether the STA 104 is affiliated with a non-AP MLD. In some implementations, the STA 104 may transmit the first frame 304 as the (re)association request frame in scenarios in which the STA 104 intends to operate in one or more operation modes (approximately) immediately after associated with the AP 102.

In association with receiving the first frame 304, the AP 102 may transmit a second frame 312 to the STA 104. In other words, the AP 102 that receives the first frame 304 from the STA 104 carrying a parameter update element may be expected to respond to the first frame 304. The response frame (such as the second frame 312) may be a corresponding response to the request sent by the STA 104. For example, if the STA 104 sends the first frame 304 as a Multi-Link Operation Update Request frame, the AP 102 may transmit the second frame 312 as a Multi-Link Operation Update Response frame. By way of further example, if the STA 104 sends the first frame 304 as a Link Reconfiguration Request frame, the AP 102 may transmit the second frame 312 as a Link Reconfiguration Response frame.

The AP 102 may be expected to transmit the second frame 312 responsive to the first frame 304 within a specific time, such as within a window or prior to an expiration of a timer. In some implementations, the specific time within which the AP 102 may be expected to respond to the first frame 304 may be indicated by the AP 102 (such as via one or more management frames, such as beacon frames, among other examples) or by the STA 104 (such as via the request frame, such as the first frame 304).

The AP 102 may accept, confirm, notify, reject, or negotiate the request to enable/update one or more parameters associated with one or more operation modes. For example, the second frame 312 may include second information 314 that includes an indication 316 of an acceptance, a confirmation, a notification, a rejection, or a negotiation of at least one of the set of requested states 308 or the one or more requested parameter sets 310. In some aspects, the expectation for the AP 102 to respond to the first frame 304 may be operation mode-specific or parameter-specific. For example, the AP 102 may be expected to accept an enablement of the DUO mode but may be allowed to reject or negotiate an enablement of the DSO mode, among other examples. In some implementations, the AP 102 may include a status code subfield (a STATUS code subfield) to indicate a status of the request by the STA 104. The status code subfield may indicate whether the request by the STA 104 is accepted or rejected, or whether a new parameter set is proposed. For example, the status code subfield may indicate at least one of ACCEPTED, REJECTED, or PROPOSED. In some examples, the second frame 312 may include a status code subfield for each operation mode of one or more operation modes (such as for each operation mode of the full set of operation modes or for each operation mode requested to be enabled by the STA 104). The status code subfield may be present within the frame body or within a parameter update element (such that the status code subfield may be one of the fields illustrated or labeled herein as “other fields”).

In some implementations, an “acceptance” may indicate that the AP 102 agrees to implement the requested states or parameter sets as specified by the STA 104. A “confirmation” may indicate that the AP 102 acknowledges the STA’s request and confirms that the requested states or parameter sets are already in effect or will be implemented. A “notification” may indicate that the AP 102 is informing the STA 104 of the current or planned states or parameter sets, which may or may not align with the STA’s request. A “rejection” may indicate that the AP 102 cannot or will not implement the requested states or parameter sets, such as due to resource constraints, policy restrictions, or incompatibility with other network operations. A “negotiation” may indicate that the AP 102 proposes alternative parameter values or states that differ, at least in part, from those requested by the STA 104, such as when the exact requested parameters are not feasible but similar parameters can be accommodated. In scenarios in which a request is rejected, the STA 104 may transmit a subsequent request with modified parameters, may accept the rejection and continue operating with existing parameters, or may attempt to associate with another AP 102 (such as if the rejected parameters are critical for the STA’s operation).

In some implementations, the AP 102 may include a parameter update element in the second frame 312. In such implementations, for example, the AP 102 may provide (such as carry, indicate, or include) the second information 314, or at least a portion thereof, within one or more parameter update elements. Additionally, or alternatively, a presence or content of the parameter update element may be associated with (such as conditioned by) whether the request by the STA 104 is accepted. For example, if the request by the STA 104 is accepted, the AP 102 may omit the parameter update element from the second frame 312 or the parameter update element may be set to the same values indicated by the STA 104 (such as the values indicated by the first information 306). By way of further example, if the request by the STA 104 is rejected, the AP 102 may omit the parameter update element from the second frame 312 (which may at least implicitly indicate that previous or current parameters are still in effect) or may include the parameter update element (to indicate the current parameters that differ from the parameters requested by the STA 104). By way of further example, if an alternate parameter set is proposed by the AP 102, the AP 102 may provide the parameter update element with (such as indicative of) the proposed parameter set in the second frame 312.

In some implementations, STAs 104 and APs 102 may support a same format associated with a parameter update element. In other words, for example, UHR-compliant APs and non-APs may transmit a same element in accordance with a unified design of the parameter update element. In such implementations, an interpretation of one or more fields or elements within the element may be different depending on (such as based on or otherwise in accordance with) whether the element is transmitted by the AP 102 or the STA 104. For example, devices may support a first interpretation of one or more fields or elements of the parameter update element in scenarios in which a frame including the parameter update element is transmitted by the AP 102 and may support a second interpretation of one or more fields or elements of the parameter update element in scenarios in which a frame including the parameter update element is transmitted by the STA 104. By way of further example, a timer field in the “other fields” may be interpreted, when transmitted by the STA 104, as the time within which the AP 102 may be expected to enable a requested operation mode or update one or more parameters associated with one or more operation modes (per the request indicated by the first information 306).

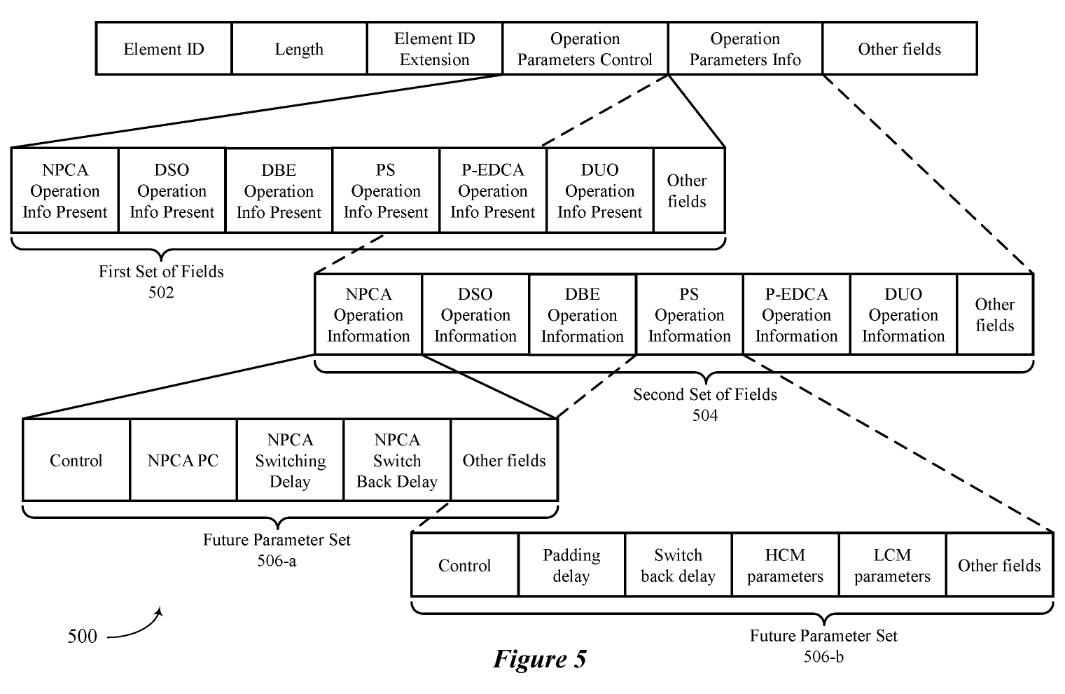

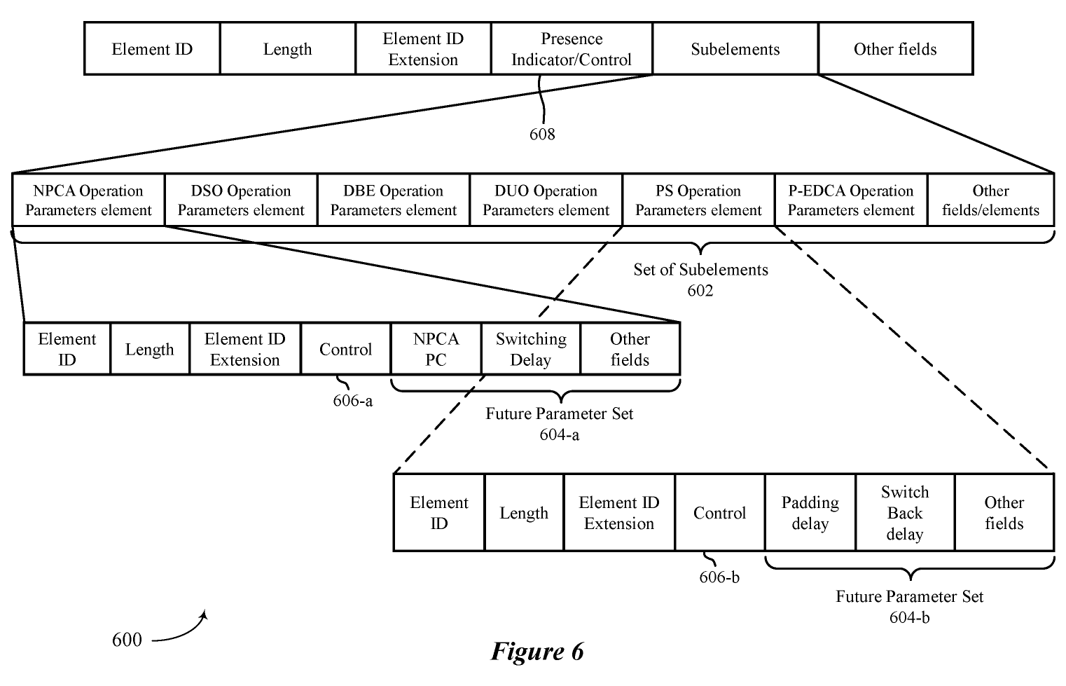

In such implementations in which the STA 104 and the AP 102 support a unified design of the parameter update element, the format of the parameter update element may be a union of fields/elements that can be transmitted by the AP 102 and by the STA 104. As a result, in scenarios in which a device (an AP or a non-AP) transmits the parameter update element, the parameter update element may include one or more presence indicators to indicate which fields or subelements are present within the parameter update element. For example, one or more presence indicators may be set to “0” (such as when the parameter update element 500 is used as illustrated by FIG. 5). When the parameter update element 600 is used, as illustrated by FIG. 6, the device may be expected (in accordance with a network specification) to exclude one or more subelements from the parameter update element. The subelements that the device may exclude from the parameter update element may include subelements that are not applicable to, or that correspond to operation modes not controllable by, the device. For example, the AP 102 may be expected to set a DUO operation information present bit to “0” (to indicate that DUO operation information is not present within the parameter update element), while the STA 104 may be expected to set a P-EDCA operation information present bit to “0” (to indicate that P-EDCA operation information is not present within the parameter update element).

The STA 104 may provide the first information 306 in accordance with one or more of various signaling protocols, which may be used independently or in any combination. Such signaling protocols are illustrated by and described with reference to FIGS. 5-10. Each of FIGS. 5-10 illustrate a respective element or frame format, which the STA 104 may use independently or in any combination to provide the first information 306, or any portion thereof. In other words, the STA 104 may provide the first information 306 via any combination of any one or more fields or elements illustrated by FIGS. 5-10. Additionally, or alternatively, the AP 102 may provide the second information 314 via any combination of any one or more fields or elements illustrated by FIGS. 4-10.

As described herein, an “element” or “subelement” may refer to a set of one or more subelements or fields that collectively provide information associated with a specific operation mode or a specific feature. Further, in some examples, an element or a subelement may be demarcated by a set of one or more specific (initial) fields. For example, an element or a subelement may begin with an element ID field (or a subelement ID field) and may end prior to a next element ID field (or a next subelement ID field). Different elements or subelements may be demarcated by different element or subelement IDs. By way of further example, each element or subelement may include at least an element (or subelement) ID field, a length field, an element ID extension field, and a control field. In some examples, an element or a subelement may include no more than a single element (or subelement) ID field, a single length field, a single element ID extension field, and a single control field. An element or a subelement may optionally, selectively, or conditionally include one or more fields after a control field that provide additional information associated with the specific operation mode or a specific feature to which the element or subelement corresponds. An element or a subelement may be considered as ended (and a next element or subelement as started) when a next element (or subelement) ID field is parsed or identified.

FIG. 4 shows an example UHR operation element 400 that supports parameter updates for ultra-high reliability operation modes. The UHR operation element 400 illustrates an example of an element via which an AP 102 may indicate at least one of the first information 206 or the second information 208, as illustrated by and described with reference to FIG. 2. The design of the UHR operation element 400 may be understood or referred to herein as an Option 1 signaling protocol. In accordance with the UHR operation element 400, the AP 102 may indicate current operation parameters (via the first information 206) and updated (such as future) operation parameters (via the second information 208) in the same element (such as the UHR operation element 400).

In some examples, the UHR operation element 400 may include a UHR operation parameters field that indicates which fields are present in a UHR operation information field. The UHR operation parameters field also may indicate which operation modes (such as which features or mechanisms) are currently enabled by the AP 102. In some examples, the UHR operation element 400 may include a future UHR operation parameters field that indicates which fields are present in a future UHR operation information field. The future UHR operation parameters field also may indicate which operation modes (such as which features or mechanisms) are undergoing (such as associated with) an update. The UHR operation information field may carry current operation parameters (such as before an update is applied) used by the AP 102. The future UHR operation information field may carry the future operation parameters (such as after the update has been applied) planned, expected, or scheduled to be used by the AP 102.

The UHR operation parameters field may include a first set of fields 402. The first set of fields 402 may indicate the set of current states 210 associated with a first set of operation modes. Each field of the first set of fields 402 may correspond to a respective operation mode of the first set of operation modes. In some examples, each field of the first set of fields 402 may indicate at least one of whether a corresponding operation mode is enabled by the AP 102 or whether a corresponding operation information field is present in the UHR operation information field. For example, if a field of the first set of fields 402 is set to “1,” the corresponding operation mode is currently enabled by the AP 102 and the corresponding operation information field is present in the UHR operation information field. By way of further example, if a field of the first set of fields 402 is set to “0,” the corresponding operation mode is currently disabled by the AP 102 and the corresponding operation information field is not present in the UHR operation information field.

The future UHR operation parameters field may include a second set of fields 404. The second set of fields 404 may indicate the set of future states 214 associated with a second set of operation modes (which may be the same as or at least partially different from the first set of operation modes). Each field of the second set of fields 404 may correspond to a respective operation mode of the second set of operation modes. In some examples, each field of the second set of fields 404 may indicate at least one of whether a corresponding operation mode will be enabled (is changed to become enabled or will remain enabled) by the AP 102 after the update has occurred or whether the updated parameter values are included in the future UHR operation information field. For example, if a field of the second set of fields 404 is set to “1,” the corresponding mode will be enabled by the AP 102 after the update has occurred and the corresponding operation information field in the future UHR operation information field carries the updated parameter values. By way of further example, if a field of the second set of fields 404 is set to “0,” the corresponding mode will be disabled by the AP 102 after the update has occurred and the corresponding operation information field is not present within the future UHR operation information field.

The UHR operation information field may include a third set of fields 406. The third set of fields 406 may indicate the one or more current parameter sets 212 associated with one or more first operation modes of the set of operation modes. Each field of the third set of fields 406 may correspond to a respective operation mode of the one or more first operation modes. The one or more first operation modes may include at least one operation mode that is currently enabled. In some examples, each field of the third set of fields 406 carries one or more subfields that indicate the values of the corresponding operation mode parameters. For example, an NPCA operation information field includes an indication of at least one of an NPCA primary channel, an NPCA switching delay, or an NPCA switch back delay, among other examples.

The future UHR operation information field may include a fourth set of fields 408. The fourth set of fields 408 may indicate the one or more future parameter sets 216 associated with one or more second operation modes of the set of operation modes. Each field of the fourth set of fields 408 may correspond to a respective operation mode of the one or more second operation modes. The one or more second operation modes may include at least one operation mode that will be enabled by the AP 102 after the update has been applied. In some examples, each field of the fourth set of fields 408 carries one or more subfields which indicate the future values of the corresponding operation mode parameters (such as the updated parameter values that will be used after the update has occurred). By way of example, an NPCA operation information field of the fourth set of fields 408 may indicate a future parameter set 410, which may indicate one or more future parameters associated with an NPCA mode that will become effective (such as be applied) at some point in the future.

In some implementations, for the future parameters, in addition to the values of the future parameters, the AP 102 may provide information associated with (such as indicative of) when the update(s) will take effect. For example, the AP 102 may indicate a time reference, such as a quantity of TBTTs, a quantity of delivery traffic indication message (DTIM) intervals, a quantity of microseconds, or any other time domain indication. The time reference may be at least a threshold duration in the future relative to a transmission time of a frame carrying the UHR operation element 400. A threshold duration, as used herein, may be a threshold quantity of beacon intervals, a threshold quantity of DTIM intervals, a threshold quantity of microseconds, a threshold quantity of slots, or a threshold quantity of any other time domain unit. The AP 102 may indicate the time reference via any one or more of the “other fields” of the UHR operation element 400. A time reference may be universally applicable to the set of operation modes, more specifically applicable to the one or more second operation modes, more specifically applicable to one or more select operation modes of the one or more second operation modes, or more specifically applicable to one or more select parameters associated with an operation mode of the one or more second operation modes.

A location of an indication of a time reference within the UHR operation element 400 may (implicitly) indicate to which operation mode(s) or which parameter(s) the time reference is applicable. For example, a time reference indicated by a field within the “other fields” of the second set of fields 404 may indicate that the time reference is applicable to the set of operation modes. By way of further example, a time reference indicated by a field within the “other fields” of the fourth set of fields 408 may indicate that the time reference is applicable to the one or more second operation modes. By way of further example, a time reference indicated by a field within the “other fields” of the future parameter set 410 may indicate that the time reference is applicable to the one or more parameters indicated by the future parameter set 410. The AP 102 may indicate a single time reference or may indicate multiple time references via the UHR operation element 400. In examples in which multiple time references are indicated, updates associated with different operation mode(s) or parameter(s) may occur at respective times (in accordance with their respectively indicated time references). The respective times may be the same or may be at least partially different.

FIG. 5 shows an example parameter update element 500 that supports parameter updates for ultra-high reliability operation modes. The parameter update element 500 illustrates an example of an element via which an AP 102 may indicate at least one of the first information 206 or the second information 208, as illustrated by and described with reference to FIG. 2. The parameter update element 500 also illustrates an example of an element via which a STA 104 may indicate at least the first information 306, as illustrated by and described with reference to FIG. 3. The design of the parameter update element 500 may be understood or referred to herein as an Option 2A signaling protocol. The Option 2A signaling protocol may be associated with carrying parameters of one or more operation modes as subfields within the parameter update element 500.

In some implementations, the AP 102 may indicate current operation parameters (via the first information 206) in a first element (such as a UHR operation element, such as a version of the UHR operation element 400 that excludes the future UHR operation parameters field and the future UHR operation information field) and may indicate updated (such as future) operation parameters (via the second information 208) in a second element (such as the parameter update element 500). The parameter update element 500 may be equivalently referred to as a critical update element, a special update element, or a select update element, among other examples.

An operation parameters control field of the parameter update element 500 may indicate a presence or an absence of fields in an operation parameters information field. The operation parameters control field may include a first set of fields 502. The first set of fields 502 may indicate the set of future states 214 associated with the set of operation modes (or at least one future state associated with at least one operation mode of the set of operation modes). Each field of the first set of fields 502 may correspond to a respective operation mode of the set of operation modes. In some examples, each field of the first set of fields 502 may indicate at least one of whether a corresponding operation mode will be enabled by the AP 102 after the update has occurred or whether a corresponding operation information field is present in the operation parameters information field. For example, if a field of the first set of fields 502 indicates “1,” a corresponding operation mode will be enabled by the AP 102 after the update has occurred and a corresponding operation information field may be present in the operation parameters information field. By way of further example, if a field of the first set of fields 502 indicates “0,” a corresponding operation mode will be disabled by the AP 102 after the update has occurred and a corresponding operation information field may not be present in the operation parameters information field.

The operation parameters information field may carry the operation parameters for one or more second operation modes. The one or more second operation modes may include at least one operation mode that the AP 102 will enable after the update has occurred. For example, the operation parameters information field may include a second set of fields 504. The second set of fields 504 may indicate the one or more future parameter sets 216 associated with the one or more second operation modes of the set of operation modes. In some examples, each field of the second set of fields 504 carries one or more subfields that indicate the future values of the corresponding operation mode parameters (such as the updated values for one or more parameters after the update has occurred). For example, if an NPCA mode is indicated as being enabled by the AP 102 after the update has occurred, the second set of fields 504 may include an NPCA operation information field that indicates a future parameter set 506-a. The future parameter set 506-a may include one or more future parameters associated with the NPCA mode (that may become effective after the update has occurred). By way of further example, if a PS mode (such as a DPS mode or an AP PS mode) is indicated as being enabled by the AP 102 after the update has occurred, the second set of fields 504 may include a PS operation information field that indicates a future parameter set 506-b. The future parameter set 506-b may include one or more future parameters associated with the PS mode (that may become effective after the update has occurred).

In some implementations, for the future parameters, in addition to the values of the future parameters, the AP 102 also may provide information associated with (such as indicative of) when the update(s) will take effect. The AP 102 may indicate when the update(s) become effective by indicating a time reference, such as a quantity of TBTTs, a quantity of DTIM intervals, a quantity of microseconds, or any other time domain indication. The time reference may be at least a threshold duration in the future relative to a transmission time of a frame carrying the parameter update element 500. The AP 102 may indicate the time reference via any one or more of the “other fields” of the parameter update element 500. A time reference may be universally applicable to the set of operation modes, more specifically applicable to the one or more second operation modes, more specifically applicable to one or more select operation modes of the one or more second operation modes, or more specifically applicable to one or more select parameters associated with an operation mode of the one or more second operation modes. A location of an indication of a time reference within the parameter update element 500 may (implicitly) indicate to which operation mode(s) or which parameter(s) the time reference is applicable, as described in more detail with reference to FIG. 4. The AP 102 may indicate a single time reference or may indicate multiple time references via the parameter update element 500. In examples in which multiple time references are indicated, updates associated with different operation mode(s) or parameter(s) may occur at respective times (in accordance with their respectively indicated time references). The respective times may be the same or may be at least partially different.

In some implementations, the STA 104 may indicate (via the first information 306) requested states or parameters associated with one or more operation modes in accordance with the parameter update element 500. In such implementations in which the STA 104 transmits a frame including the parameter update element 500, the first set of fields 502 may indicate the set of requested states 308 associated with the set of operation modes and the second set of fields 504 may indicate the one or more requested parameter sets 310 associated with one or more operation modes of the set of operation modes. The one or more operation modes may include at least one operation mode that the STA 104 requests to be enabled.

In such implementations, each field of the first set of fields 502 may indicate at least one of whether a corresponding operation mode is requested to be enabled by the STA 104 or whether a corresponding operation information field is present in the operation parameters information field. For example, if a field of the first set of fields 502 is set to “1,” a corresponding operation mode may be requested to be enabled by the STA 104 and a corresponding operation information field may be present in the operation parameters information field. By way of further example, if a field of the first set of fields 502 is set to “0,” a corresponding operation mode may be requested to be disabled by the STA 104 and a corresponding operation information field may be not present in the operation parameters information field.

Further, in implementations in which the STA 104 transmits a frame including the parameter update element 500, the “other fields” of the parameter update element 500 may carry a timer value. When transmitted by the STA 104 (a non-AP STA), the timer value may indicate the time requested by the STA 104 within which the STA 104 expects an AP 102 to enable one or more operation modes or update one or more parameters provided by the STA 104. The timer value may be universally applicable to the set of operation modes, more specifically applicable to the one or more operation modes, more specifically applicable to one or more select operation modes of the one or more operation modes, or more specifically applicable to one or more select parameters associated with an operation mode of the one or more operation modes. A location of an indication of a timer value within the parameter update element 500 may (implicitly) indicate to which operation mode(s) or which parameter(s) the timer value is applicable, as described in more detail with reference to FIG. 4. The STA 104 may indicate a single timer value or may indicate multiple timer values via the parameter update element 500. In examples in which multiple timer values are indicated, updates associated with different operation mode(s) or parameter(s) may be requested to occur at respective times (in accordance with their respectively indicated timer values). The respective times may be the same or may be at least partially different.

FIG. 6 shows an example parameter update element 600 that supports parameter updates for ultra-high reliability operation modes. The parameter update element 600 illustrates an example of an element via which an AP 102 may indicate at least one of the first information 206 or the second information 208, as illustrated by and described with reference to FIG. 2. The parameter update element 600 also illustrates an example of an element via which a STA 104 may indicate at least the first information 306, as illustrated by and described with reference to FIG. 3. The design of the parameter update element 600 may be understood or referred to herein as an Option 2B signaling protocol. The Option 2B signaling protocol may be associated with carrying parameters of one or more operation modes as subelements within the parameter update element 600.

In some implementations, the AP 102 may indicate current operation parameters (via the first information 206) in a first element (such as a UHR operation element, such as a version of the UHR operation element 400 that excludes the future UHR operation parameters field and the future UHR operation information field) and may indicate updated (such as future) operation parameters (via the second information 208) in a second element (such as the parameter update element 600). The parameter update element 600 may be equivalently referred to as a critical update element, among other examples.

In implementations in which the AP 102 transmits a frame including the parameter update element 600, a set of subelements 602 may indicate the second information 208. Each subelement of the set of subelements 602 may correspond to a respective operation mode of a set of operation modes. Each subelement of the set of subelements 602 may include a set of fields that indicate information associated with a corresponding operation mode. For example, the set of subelements 602 may include an NPCA operation parameters element that indicates a future parameter set 604-a. The future parameter set 604-a may include one or more parameters associated with the NPCA mode. By way of further example, the set of subelements 602 may include a PS operation parameters element that indicates a future parameter set 604-b. The future parameter set 604-b may include one or more parameters associated with the PS mode.

In some implementations, each subelement of the set of subelements 602 may include a control field. For example, the NPCA operation parameters element may include a control field 606-a and the PS operation parameters element may include a control field 606-b. Each control field may indicate a presence of one or more fields after the control field. For example, the control field 606-a may indicate a presence or absence of an NPCA primary channel field (illustrated as “NPCA PC” in the example of FIG. 6), a presence or absence of a switching delay field, among other examples. In some implementations, each control field may indicate if the corresponding operation mode is enabled by the AP 102 after the update has taken effect.

In some implementations, the parameter update element 600 may include a presence indicator/control field 608. In implementations in which the parameter update element 600 includes the presence indicator/control field 608 (such as if the presence indicator/control field 608 is defined), the presence indicator/control field 608 may carry a bitmap (similar to an operation parameters control field of the parameter update element 500). Each bit of the bitmap may indicate at least one of whether a corresponding operation mode is enabled by the AP 102 after the update occurs or whether the corresponding operation parameters element is present in the set of subelements 602. For example, if a bit is set to “1,” a corresponding operation mode may be enabled by the AP 102 after the update occurs and a corresponding operation parameters element (such as the corresponding operation information field) is present in the set of subelements 602. By way of further example, if a bit is set to “0,” a corresponding operation mode may be disabled by the AP 102 after the update occurs and a corresponding operation parameters element (such as a corresponding operation information field) is not present in the set of subelements 602.

In implementations in which the parameter update element 600 excludes the presence indicator/control field 608 (such as if the presence indicator/control field 608 is not defined), the parameter update element 600 may implicitly indicate a state associated with each operation mode of the set of operation modes. For example, if a specific operation mode’s operation parameters element is included in the set of subelements 602, the parameter update element 600 may implicitly indicate that the corresponding operation mode is enabled by the AP 102 after the update occurs and the fields inside of the operation parameters field indicate the values of the corresponding parameters after the update has taken effect. By way of further example, if a specific operation mode’s operation parameters element is not included in the set of subelements 602, an interpretation rule may define that the corresponding mode may be disabled by the AP 102 after the update occurs or that there is no change to the states or parameters of the corresponding operation mode.

In some implementations, for the future parameters, in addition to the values of the future parameters, the AP 102 also may provide information associated with (such as indicative of) when the update(s) will take effect. The AP 102 may indicate when the update(s) become effective by indicating a time reference, such as a quantity of TBTTs, a quantity of DTIM intervals, a quantity of microseconds, or any other time domain indication. The time reference may be at least a threshold duration in the future relative to a transmission time of a frame carrying the parameter update element 600. The AP 102 may indicate the time reference via any one or more of the “other fields” of the parameter update element 600. A time reference may be universally applicable to the set of operation modes, more specifically applicable to the one or more second operation modes, more specifically applicable to one or more select operation modes of the one or more second operation modes, or more specifically applicable to one or more select parameters associated with an operation mode of the one or more second operation modes. A location of an indication of a time reference within the parameter update element 600 may (implicitly) indicate to which operation mode(s) or which parameter(s) the time reference is applicable, as described in more detail with reference to FIG. 4. The AP 102 may indicate a single time reference or may indicate multiple time references via the parameter update element 600. In examples in which multiple time references are indicated, updates associated with different operation mode(s) or parameter(s) may occur at respective times (in accordance with their respectively indicated time references). The respective times may be the same or may be at least partially different.

In implementations in which the STA 104 transmits a frame including the parameter update element 600, a control field within each subelement of the set of subelements 602 may indicate a presence or an absence of one or more fields after the control field. For example, within an NPCA operation parameters element, a control field may indicate a presence or an absence of a switch delay field or a presence or an absence of a switch back delay field, among other examples. The control field within each subelement of the set of subelements 602 also may indicate if the corresponding operation mode is requested to be enabled by the STA 104. For example, the STA 104 may request to disable the NPCA mode without providing any NPCA-related parameters in the NPCA operation parameters element.

In implementations in which the parameter update element 600 includes a presence indicator/control field 608, the presence indicator/control field 608 may carry a bitmap. Each bit of the bitmap may correspond to a respective operation mode of the set of operation modes. Each bit of the bitmap may indicate at least one of whether a corresponding operation mode is requested to be enabled by the STA 104 or whether a corresponding operation parameters element is present within the set of subelements 602. For example, if a bit in the bitmap is set to “1,” a corresponding operation mode may be requested to be enabled by the STA 104 and a corresponding operation parameters element may be present in the set of subelements 602. By way of further example, if a bit in the bitmap is set to “0,” a corresponding operation mode may be requested to be disabled by the STA 104 and a corresponding operation parameters element may not be present in the set of subelements 602.

In implementations in which the parameter update element 600 excludes the presence indicator/control field 608, the parameter update element 600 may implicitly indicate a state associated with each operation mode of the set of operation modes. For example, if a specific operation mode’s operation parameters element is included in the set of subelements 602, the corresponding operation mode may be requested to be enabled by the STA 104 and the fields inside the operation parameters element may indicate the values of the corresponding parameters requested by the STA 104. By way of further example, if a specific operation mode’s operation parameters element is not included in the set of subelements 602, an interpretation rule may define that the corresponding operation mode is requested to be disabled by the STA 104 or that no change to the state/parameters associated with the corresponding operation mode is requested.

Further, in implementations in which the STA 104 transmits a frame including the parameter update element 600, the “other fields” of the parameter update element 600 may carry a timer value. When transmitted by the STA 104 (a non-AP STA), the timer value may indicate the time requested by the STA 104 within which the STA 104 expects an AP 102 to enable one or more operation modes or update one or more parameters provided by the STA 104. The timer value may be universally applicable to the set of operation modes, more specifically applicable to the one or more operation modes, more specifically applicable to one or more select operation modes of the one or more operation modes, or more specifically applicable to one or more select parameters associated with an operation mode of the one or more operation modes. A location of an indication of a timer value within the parameter update element 600 may (implicitly) indicate to which operation mode(s) or which parameter(s) the timer value is applicable, as described in more detail with reference to FIG. 4. The STA 104 may indicate a single timer value or may indicate multiple timer values via the parameter update element 600. In examples in which multiple timer values are indicated, updates associated with different operation mode(s) or parameter(s) may be requested to occur at respective times (in accordance with their respectively indicated timer values). The respective times may be the same or may be at least partially different.

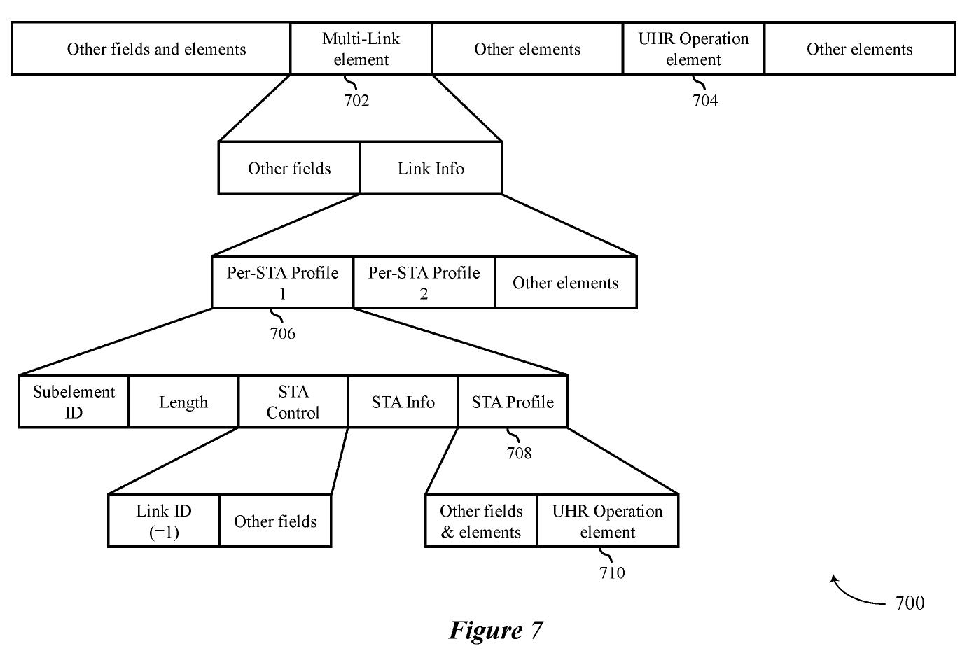

FIG. 7 shows an example frame format 700 that supports parameter updates for ultra-high reliability operation modes. The frame format 700 illustrates an example of a frame via which an AP 102 may indicate at least one of the first information 206 or the second information 208, as illustrated by and described with reference to FIG. 2, along with additional information (such as third information) associated with one or more future states or parameters associated with one or more reported links. The design of the frame format 700 may be understood or referred to herein as an Option 3A + Option 1 signaling protocol. The Option 3A + Option 1 signaling protocol may be associated with carrying information associated with a reporting link within a frame body and information associated with one or more reported links inside a multi-link element 702. In accordance with the frame format 700, one or more future states or parameters may be indicated via a UHR operation element, such as the UHR operation element 400, within the transmitted frame.

The AP 102 may transmit the frame (such as a management frame, such as a beacon frame or a probe response frame) via a link 0. The frame may include the multi-link element 702. The multi-link element 702 may be a basic multi-link element, a reconfiguration multi-link element, or a variant of the multi-link element dedicated to conveying future parameters associated with one or more operation modes (such as a parameter update multi-link element). If the multi-link element 702 is not a basic multi-link element, the multi-link element may only be present in scenarios in which one or more of the other links of the AP MLD have an upcoming update. The frame may further include a UHR operation element 704. The UHR operation element 704, which may be an example of the UHR operation element 400, may carry current and future values of one or more parameters associated with one or more operation modes. In some aspects, the UHR operation element 704 may only include future values in scenarios in which there is a future update scheduled to occur. In other words, the UHR operation element 704 may include the first information 206 and the second information 208.

The multi-link element 702 may include a link information field, which may, if in a basic multi-link element, only be present if one or more of the other links of the AP MLD have an upcoming update. The link information field may include one or more per-STA profiles. Each per-STA profile may correspond to a respective link of the AP MLD. The per-STA profile corresponding to a link may only be present if there is an upcoming update for that link. Otherwise, the per-STA profile corresponding to that link may be excluded from the link information field. By way of example, the link information field may include a per-STA profile 706 associated with a link 1 of the AP MLD (as indicated by a link ID within a STA control field in the per-STA profile 706). The per-STA profile 706 may include a STA profile 708, which includes a UHR operation element 710. The UHR operation element 710 may include information associated with an upcoming update associated with the link 1 of the AP MLD. For example, the UHR operation element 710 may include third information (associated with the link 1 of the AP MLD) that indicates a set of future states associated with a set of operation elements and indicates one or more future parameter sets associated with one or more third operation elements of the set of operation elements.

FIG. 8 shows an example frame format 800 that supports parameter updates for ultra-high reliability operation modes. The frame format 800 illustrates an example of a frame via which an AP 102 may indicate at least one of the first information 206 or the second information 208, as illustrated by and described with reference to FIG. 2, along with additional information (such as third information) associated with one or more future states or parameters associated with one or more reported links. The frame format 800 also illustrates an example of a frame via which a STA 104 may indicate at least the first information 306, as illustrated by and described with reference to FIG. 3, along with additional information associated with one or more requested states or parameters associated with one or more reported links. The design of the frame format 800 may be understood or referred to herein as an Option 3A + Option 2 signaling protocol. The Option 3A + Option 2 signaling protocol may be associated with carrying information of a reporting link within a frame body and information of one or more reported links inside a multi-link element 802.

The AP 102 or the STA 104 may transmit the frame (such as a management frame, such as a beacon frame or a probe response frame, or another frame such as an action frame, a notification frame, or a (re)association request frame) via a link 0. The frame may include the multi-link element 802. The multi-link element 802 may be a basic multi-link element, a reconfiguration multi-link element, or a variant of the multi-link element dedicated to conveying future parameters associated with one or more operation modes (such as a parameter update multi-link element). If the multi-link element 802 is not a basic multi-link element, the multi-link element may only be present in scenarios in which one or more of the other links of the AP MLD or the non-AP MLD have an upcoming update.

The frame may further include a UHR operation element 804 or a parameter update element 806. The UHR operation element 804 may be present in examples in which the frame is transmitted by the AP 102 and may be absent in examples in which the frame is transmitted by the STA 104. The UHR operation element 804 may carry current values of one or more parameters associated with one or more operation modes. For example, the UHR operation element 804 may indicate the first information 206. The parameter update element 806 may carry future (if transmitted by the AP 102) or requested (if transmitted by the STA 104) values of one or more parameters associated with one or more operation modes. The parameter update element 806 may carry future/requested values of one or more operational parameters associated with the link 0 via which the frame is transmitted. For example, the parameter update element 806 may indicate the second information 208 (if transmitted by the AP 102) or the first information 306 (if transmitted by the STA 104). The parameter update element 806 may be an example of the parameter update element 500 or the parameter update element 600.

The multi-link element 802 may include a link information field, which may, if in a basic multi-link element, only be present if one or more of the other links of the AP MLD or the non-AP MLD have an upcoming update. The link information field may include one or more per-STA profiles. Each per-STA profile may correspond to a respective link of the AP MLD or the non-AP MLD. The per-STA profile corresponding to a link may only be present if there is an upcoming update for that link. Otherwise, the per-STA profile corresponding to that link may be excluded from the link information field. By way of example, the link information field may include a per-STA profile 808 associated with a link 1 of the AP MLD or the non-AP MLD (as indicated by a link ID within a STA control field in the per-STA profile 808). The per-STA profile 808 may include a STA profile 810, which includes a parameter update element 812. The parameter update element 812 may include information associated with an upcoming update associated with the link 1 of the AP MLD or the non-AP MLD. For example, the parameter update element 812 may include information (associated with the link 1 of the AP MLD or the non-AP MLD) that indicates a set of future (if transmitted by the AP 102) or requested (if transmitted by the STA 104) states associated with a set of operation elements and indicates one or more future (if transmitted by the AP 102) or requested (if transmitted by the STA 104) parameter sets associated with one or more operation elements of the set of operation elements.

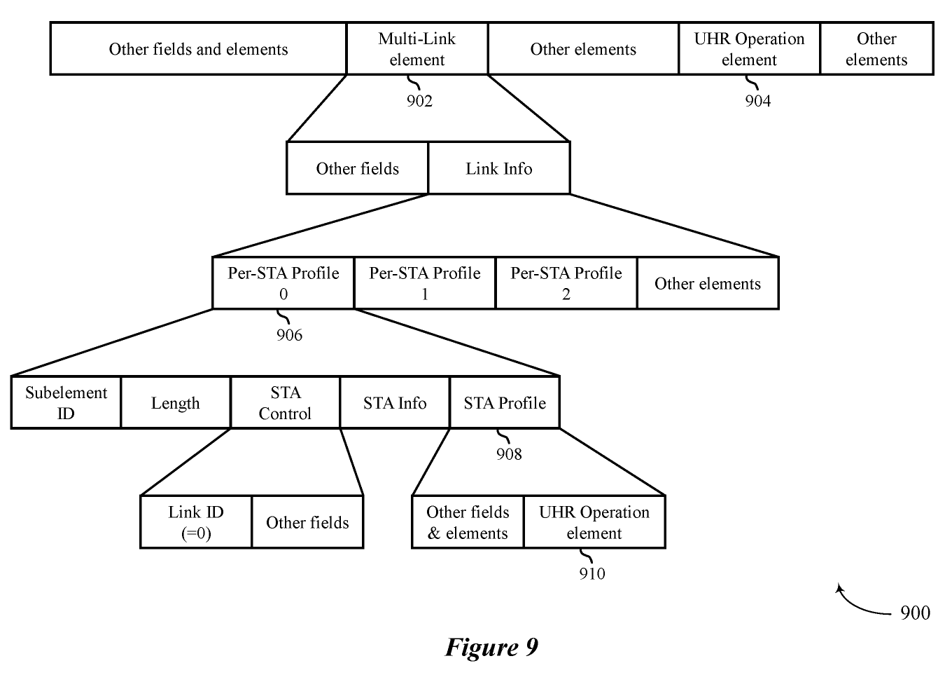

FIG. 9 shows an example frame format 900 that supports parameter updates for ultra-high reliability operation modes. The frame format 900 illustrates an example of a frame via which an AP 102 may indicate at least one of the first information 206 or the second information 208, as illustrated by and described with reference to FIG. 2, along with additional information (such as third information) associated with one or more future states or parameters associated with one or more reported links. The design of the frame format 900 may be understood or referred to herein as an Option 3B + Option 1 signaling protocol. The Option 3B + Option 1 signaling protocol may be associated with carrying information of a reporting link and one or more reported links inside a multi-link element 902.

The AP 102 may transmit the frame (such as a management frame, such as a beacon frame or a probe response frame) via a link 0. The frame may include the multi-link element 902. The multi-link element 902 may be a basic multi-link element, a reconfiguration multi-link element, or a variant of the multi-link element dedicated to conveying future parameters associated with one or more operation modes (such as a parameter update multi-link element). If the multi-link element 902 is not a basic multi-link element, the multi-link element may only be present in scenarios in which one or more of the other links of the AP MLD have an upcoming update.

The frame may further include a UHR operation element 904. The UHR operation element 904 may carry current values of one or more parameters associated with one or more operation modes. For example, the UHR operation element 904 may include the first information 206. In some aspects, an interpretation rule may define that if a UHR operation element is carried inside the multi-link element 902 or a per-STA profile subelement, the UHR operation element carries one or more future parameters, and if a UHR operation element is carried outside a multi-link element, the UHR operation element carries one or more current parameters.

The multi-link element 902 may include a link information field, which may, if in a basic multi-link element, only be present if one or more of the other links of the AP MLD have an upcoming update. The link information field may include one or more per-STA profiles. Each per-STA profile may correspond to a respective link of the AP MLD. The per-STA profile corresponding to a link may only be present if there is an upcoming update for that link. Otherwise, the per-STA profile corresponding to that link may be excluded from the link information field. In some implementations, in addition to including per-STA profiles associated with one or more reported links, the link information field may include a per-STA profile associated with a reporting link if there is a future update upcoming for one or more states or parameters associated with one or more operation modes on the reporting link. If there is not a future update upcoming for one or more states or parameters associated with one or more operation modes on the reporting link, the link information field may exclude a per-STA profile associated with the reporting link.

By way of example, the link information field may include a per-STA profile 906 associated with the link 0 (such as the reporting link, such as the link via which the frame is transmitted) of the AP MLD (as indicated by a link ID within a STA control field in the per-STA profile 906). The per-STA profile 906 may include a STA profile 908, which includes a UHR operation element 910. The UHR operation element 910 may include information associated with an upcoming update associated with the link 0 of the AP MLD. For example, the UHR operation element 910 may include the second information 208.

FIG. 10 shows an example frame format 1000 that supports parameter updates for ultra-high reliability operation modes. The frame format 1000 illustrates an example of a frame via which an AP 102 may indicate at least one of the first information 206 or the second information 208, as illustrated by and described with reference to FIG. 2, along with additional information (such as third information) associated with one or more future states or parameters associated with one or more reported links. The frame format 1000 also illustrates an example of a frame via which a STA 104 may indicate at least the first information 306, as illustrated by and described with reference to FIG. 3, along with additional information associated with one or more requested states or parameters associated with one or more reported links. The design of the frame format 1000 may be understood or referred to herein as an Option 3B + Option 2 signaling protocol. The Option 3B + Option 2 signaling protocol may be associated with carrying information of a reporting link and one or more reported links inside a multi-link element 1002.

The AP 102 or the STA 104 may transmit the frame (such as a management frame, such as a beacon frame or a probe response frame, or another frame such as an action frame, a notification frame, or a (re)association request frame) via a link 0. The frame may include the multi-link element 1002. The multi-link element 1002 may be a basic multi-link element, a reconfiguration multi-link element, or a variant of the multi-link element dedicated to conveying future parameters associated with one or more operation modes (such as a parameter update multi-link element). If the multi-link element 1002 is not a basic multi-link element, the multi-link element 1002 may only be present in scenarios in which one or more of the other links of the AP MLD or the non-AP MLD have an upcoming update. The frame may further include a UHR operation element 1004 outside the multi-link element 1002. The UHR operation element 1004 may be present in examples in which the frame is transmitted by the AP 102 and may be absent in examples in which the frame is transmitted by the STA 104. The UHR operation element 1004 may carry current values of one or more parameters associated with one or more operation modes. For example, the UHR operation element 1004 may indicate the first information 206.

The multi-link element 1002 may include a link information field, which may, if in a basic multi-link element, only be present if one or more of the other links of the AP MLD or the non-AP MLD have an upcoming update. The link information field may include one or more per-STA profiles. Each per-STA profile may correspond to a respective link of the AP MLD or the non-AP MLD. The per-STA profile corresponding to a link may only be present if there is an upcoming update for that link. Otherwise, the per-STA profile corresponding to that link may be excluded from the link information field. In some implementations, in addition to including per-STA profiles associated with one or more reported links, the link information field may include a per-STA profile associated with a reporting link if there is a future (if transmitted by the AP 102) or requested (if transmitted by the STA 104) update upcoming for one or more states or parameters associated with one or more operation modes on the reporting link. If there is not a future (if transmitted by the AP 102) or requested (if transmitted by the STA 104) update upcoming for one or more states or parameters associated with one or more operation modes on the reporting link, the link information field may exclude a per-STA profile associated with the reporting link.

By way of example, the link information field may include a per-STA profile 1006 associated with the link 0 (such as the reporting link, such as the link via which the frame is transmitted) of the AP MLD or the non-AP MLD (as indicated by a link ID within a STA control field in the per-STA profile 1006). The per-STA profile 1006 may include a STA profile 1008, which includes a parameter update element 1010. The parameter update element 1010 may include information associated with an upcoming or requested update associated with the link 0 of the AP MLD or the non-AP MLD. For example, the parameter update element 1010 may include information (associated with the link 0 of the AP MLD or the non-AP MLD) that indicates a set of future (if transmitted by the AP 102) or requested (if transmitted by the STA 104) states associated with a set of operation elements and indicates one or more future (if transmitted by the AP 102) or requested (if transmitted by the STA 104) parameter sets associated with one or more operation elements of the set of operation elements. For example, the parameter update element 1010 may indicate the second information 208 (if transmitted by the AP 102) or the first information 306 (if transmitted by the STA 104). The parameter update element 1010 may be an example of the parameter update element 500 or the parameter update element 600.

The various signaling protocol options described herein may be selected, alone or in any combination, based on different deployment scenarios, system expectations, or device constraints or requirements. For example, the UHR operation element 400 may be selected when both current and future parameters are to be conveyed in a single element, providing a compact representation that reduces overhead. The parameter update element 500 may be selected when parameter information is carried as subfields, offering flexibility for devices that support different parameter granularities. The parameter update element 600 may be elected when parameter information is structured as subelements, enabling extensible parameter sets and simplified parsing by devices that only need specific operation mode information. The Option 3A variants may be selected for multi-link deployments where reporting link information is maintained in the frame body while reported link information is conveyed through multi-link elements. The Option 3B variants may be selected when all link information, including the reporting link, is consolidated within multi-link elements, providing uniform handling across all links. The selection among these options may depend on factors such as the complexity of the parameter updates, the number of links involved, backward compatibility requirements, the processing capabilities of the wireless communication devices, or any combination thereof.

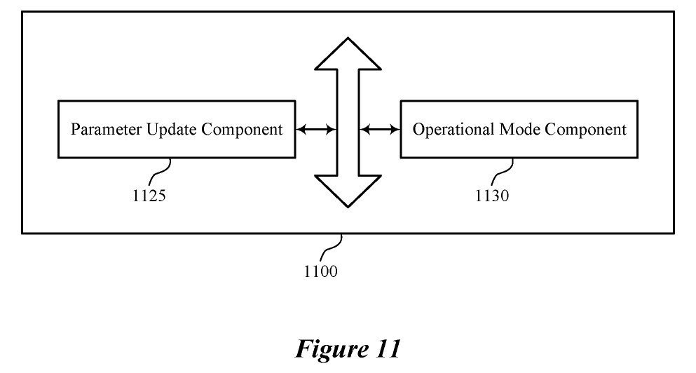

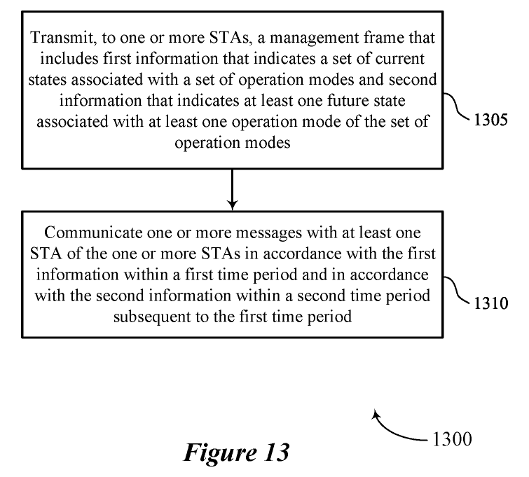

FIG. 11 shows a block diagram of an example wireless communication device 1100 that supports parameter updates for ultra-high reliability operation modes. In some examples, the wireless communication device 1100 is configured to perform the process 1300 described with reference to FIG. 13. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a parameter update component 1125 and an operational mode component 1130. Portions of one or more of the parameter update component 1125 and the operational mode component 1130 may be implemented at least in part in hardware or firmware. For example, one or more of the parameter update component 1125 and the operational mode component 1130 may be implemented at least in part by at least a processor or a modem. In some examples, portions of one or more of the parameter update component 1125 and the operational mode component 1130 may be implemented at least in part by a processor and software in the form of processor-executable code stored in memory.

The wireless communication device 1100 may support wireless communication in accordance with examples as disclosed herein. The parameter update component 1125 is configurable or configured to transmit a management frame that includes first information that indicates a set of current states associated with a set of operation modes and indicates one or more current parameter sets associated with one or more first operation modes of the set of operation modes, and that includes second information that indicates a set of future states associated with the set of operation modes and indicates one or more future parameter sets associated with one or more second operation modes of the set of operation modes. The operational mode component 1130 is configurable or configured to communicate one or more messages (such as transmit or receive one or more PPDUs, one or more acknowledgment frames, one or more trigger frames, one or more CTS frames, or one or more RTS frames, among other examples) with one or more stations (STAs) associated with the AP in accordance with the first information within a first time period and in accordance with the second information within a second time period subsequent to the first time period.

In some examples, the management frame includes the second information in accordance with at least one of a future state or a future parameter set associated with an operation mode of the set of operation modes being different from a current state or a current parameter set associated with the operation mode.

In some examples, to support communicating the one or more messages with the one or more STAs, the operational mode component 1130 is configurable or configured to communicate one or more first messages with the one or more STAs in accordance with the set of current states associated with the set of operation modes and in accordance with the one or more current parameter sets associated with the one or more first operation modes within the first time period. In some examples, to support communicating the one or more messages with the one or more STAs, the operational mode component 1130 is configurable or configured to communicate one or more second messages with the one or more STAs in accordance with the set of future states associated with the set of operation modes and in accordance with the one or more future parameter sets associated with the one or more second operation modes within the second time period subsequent to the first time period.

In some examples, the management frame includes an element that includes the first information and the second information.

In some examples, the element includes a first set of fields that indicate the set of current states associated with the set of operation modes, a second set of fields that indicate the set of future states associated with the set of operation modes, a third set of fields that indicate the one or more current parameter sets associated with the one or more first operation modes, and a fourth set of fields that indicate the one or more future parameter sets associated with the one or more second operation modes.

In some examples, the element is a UHR operation element.

In some examples, the management frame includes a first element that includes the first information and a second element that includes the second information.

In some examples, the first element includes a first set of fields that indicate the set of current states associated with the set of operation modes, and a second set of fields that indicate the one or more current parameter sets associated with the one or more first operation modes.

In some examples, the second element includes a first set of fields that indicate the set of future states associated with the set of operation modes, and a second set of fields that indicate the one or more future parameter sets associated with the one or more second operation modes.

In some examples, the second element includes a set of subelements that indicate the set of future states associated with the set of operation modes and the one or more future parameter sets associated with the one or more second operation modes. In some examples, each subelement of the set of subelements includes a field that indicates a respective future state associated with a respective operation mode of the set of operation modes. In some examples, each subelement of the set of subelements conditionally includes a respective set of fields that indicate a respective future parameter set associated with the respective operation mode in accordance with the respective future state associated with the respective operation mode.

In some examples, the second element includes one or more subelements, of a potential set of subelements, that indicate the set of future states associated with the set of operation modes and the one or more future parameter sets associated with the one or more second operation modes. In some examples, each subelement of the potential set of subelements corresponds to a respective operation mode of the set of operation modes. In some examples, a presence of the one or more subelements within, or an absence of a remainder of the potential set of subelements from, the second element indicates the set of future states associated with the set of operation modes. In some examples, each subelement of the one or more subelements includes a respective set of fields that indicate a respective future parameter set associated with the respective operation mode.

In some examples, the second element includes a field that indicates the set of future states associated with the set of operation modes, and one or more subelements that indicate the one or more future parameter sets associated with the one or more second operation modes, each subelement of the one or more subelements corresponding to a respective operation mode of the one or more second operation modes.

In some examples, the first element is a UHR operation element. In some examples, the second element is a parameter update element.

In some examples, the first information and the second information are associated with a first link of the AP via which the management frame is transmitted. In some examples, the management frame further includes third information associated with a second link of the AP. In some examples, the third information indicates a second set of future states associated with the set of operation modes and indicates one or more second future parameter sets associated with one or more third operation modes of the set of operation modes.

In some examples, the management frame includes a frame body and a multi-link element. In some examples, the frame body includes the first information and the second information. In some examples, the multi-link element includes the third information.

In some examples, the multi-link element includes a per-STA profile subelement corresponding to the second link. In some examples, the per-STA profile subelement includes a STA profile field. In some examples, the STA profile field includes an element that includes the third information.

In some examples, the element within the STA profile field that includes the second information is a UHR operation element.

In some examples, the element within the STA profile field that includes the second information is a parameter update element.

In some examples, the management frame includes a frame body and a multi-link element. In some examples, the frame body includes the first information. In some examples, the multi-link element includes the second information.

In some examples, the multi-link element includes a per-STA profile subelement corresponding to a first link via which the management frame is transmitted. In some examples, the per-STA profile subelement includes a STA profile field. In some examples, the STA profile field includes an element that includes the second information.

In some examples, the frame body includes a first UHR operation element that carries the first information. In some examples, the element within the STA profile field that includes the second information is a second UHR operation element. In some examples, an element interpretation defines that the first UHR operation element outside the multi-link element carries the first information and that the second UHR operation element inside the multi-link element carries the second information.

In some examples, the element within the STA profile field that includes the second information is a parameter update element.

In some examples, the second information includes an indication of a future time at which the set of future states and the one or more future parameter sets are to be applied.

In some examples, each current state of the set of current states indicates whether a corresponding operation mode of the set of operation modes is enabled or disabled at a current time. In some examples, each future state of the set of future states indicates whether a corresponding operation mode of the set of operation modes is enabled or disabled at a future time. In some examples, each current parameter set of the one or more current parameter sets corresponds to a respective operation mode of the one or more first operation modes. In some examples, each future parameter set of the one or more future parameter sets corresponds to a respective operation mode of the one or more second operation modes.

In some examples, the one or more first operation modes are each associated with a current state of enabled. In some examples, the one or more second operation modes are each associated with a future state of enabled.

In some examples, the one or more first operation modes and the one or more second operation modes are different sets of operation modes or are at least partially overlapping sets of operation modes.

In some examples, the set of operation modes includes at least one of a non-primary channel access mode, a dynamic sub-band operation mode, a dynamic bandwidth expansion mode, an AP power save mode, or a high-priority enhanced distributed channel access mode.

In some examples, different operation modes of the set of operation modes are associated with different parameter sets.

In some examples, the management frame includes a beacon frame, a probe response frame, an authentication frame, an action frame, an association response frame, or a reassociation response frame.

In some examples, the set of operation modes is associated with a generation of the AP. In some examples, the generation of the AP is associated with a UHR version of an IEEE 802.11 standard.

Additionally, or alternatively, the wireless communication device is configured or configurable to receive, from a station (STA), a first frame that includes first information that indicates at least one requested state associated with at least one operation mode of a set of operation modes or indicates one or more requested parameter sets associated with one or more operation modes of the set of operation modes, or both. Additionally, or alternatively, the wireless communication device is configured or configurable to transmit, to the STA, a second frame that includes second information that indicates at least one of an acceptance or a confirmation of the at least one requested state or the one or more requested parameter sets. Additionally, or alternatively, the wireless communication device is configured or configurable to communicate one or more messages with the STA in accordance with at least one of the first information or the second information.

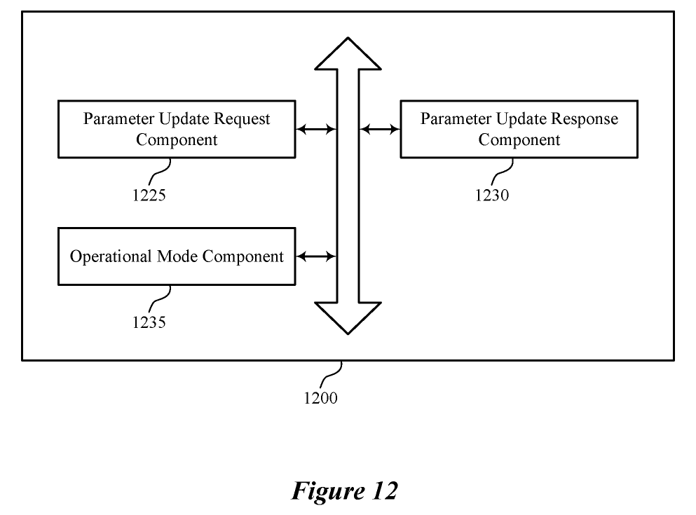

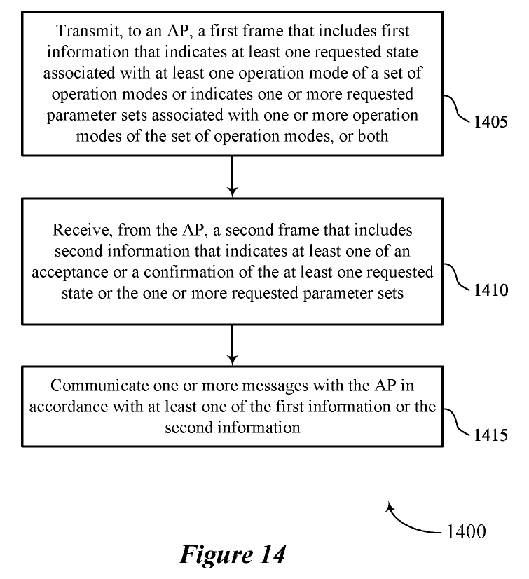

FIG. 12 shows a block diagram of an example wireless communication device 1200 that supports parameter updates for ultra-high reliability operation modes. In some examples, the wireless communication device 1200 is configured to perform the process 1400 described with reference to FIG. 14. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in a STA, such as the STA 104 described with reference to FIG. 1. In some other examples, the wireless communication device 1200 can be a STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system.

The wireless communication device 1200 includes a parameter update request component 1225, a parameter update response component 1230, and an operational mode component 1235. Portions of one or more of the parameter update request component 1225, the parameter update response component 1230, and the operational mode component 1235 may be implemented at least in part in hardware or firmware. For example, one or more of the parameter update request component 1225, the parameter update response component 1230, and the operational mode component 1235 may be implemented at least in part by at least a processor or a modem. In some examples, portions of one or more of the parameter update request component 1225, the parameter update response component 1230, and the operational mode component 1235 may be implemented at least in part by a processor and software in the form of processor-executable code stored in memory.

The wireless communication device 1200 may support wireless communication in accordance with examples as disclosed herein. The parameter update request component 1225 is configurable or configured to transmit a first frame that includes first information that indicates a set of requested states associated with a set of operation modes and indicates one or more requested parameter sets associated with one or more operation modes of the set of operation modes. The parameter update response component 1230 is configurable or configured to receive a second frame that includes second information that indicates at least one of an acceptance, a confirmation, a notification, a rejection, or a negotiation of at least one of the set of requested states or the one or more requested parameter sets. The operational mode component 1235 is configurable or configured to communicate one or more messages (such as transmit or receive one or more PPDUs, one or more acknowledgment frames, one or more trigger frames, one or more CTS frames, or one or more RTS frames, among other examples) with an access point (AP) in accordance with at least one of the first information or the second information.

In some examples, to support communicating the one or more messages with the AP, the operational mode component 1235 is configurable or configured to communicate the one or more messages with the AP in accordance with the at least one of the acceptance, the confirmation, the notification, the rejection, or the negotiation of the at least one of the set of requested states or the one or more requested parameter sets.

In some examples, the first frame includes a parameter update element that includes the first information.

In some examples, the parameter update element includes a first set of fields that indicate the set of requested states associated with the set of operation modes, and a second set of fields that indicate the one or more requested parameter sets associated with the one or more operation modes.

In some examples, the parameter update element includes a set of subelements that indicate the set of requested states associated with the set of operation modes and the one or more requested parameter sets associated with the one or more operation modes. In some examples, each subelement of the set of subelements includes a field that indicates a respective requested state associated with a respective operation mode of the set of operation modes. In some examples, each subelement of the set of subelements conditionally includes a respective set of fields that indicate a respective parameter set associated with the respective operation mode in accordance with the respective requested state associated with the respective operation mode.

In some examples, the parameter update element includes one or more subelements, of a potential set of subelements, that indicate the set of requested states associated with the set of operation modes and the one or more requested parameter sets associated with the one or more operation modes. In some examples, each subelement of the potential set of subelements corresponds to a respective operation mode of the set of operation modes. In some examples, a presence of the one or more subelements within, or an absence of a remainder of the potential set of subelements from, the parameter update element indicates the set of requested states associated with the set of operation modes. In some examples, each subelement of the one or more subelements includes a respective set of fields that indicate a respective requested parameter set associated with the respective operation mode.

In some examples, the parameter update element includes a field that indicates the set of requested states associated with the set of operation modes, and one or more subelements that indicate the one or more requested parameter sets associated with the one or more operation modes, each subelement of the one or more subelements corresponding to a respective operation mode of the one or more operation modes.

In some examples, an element interpretation of the parameter update element is associated with a type of wireless communication device that transmits a frame including the parameter update element.

In some examples, the second frame is received within a threshold amount of time relative to a transmission time of the first frame.

In some examples, the first information includes an indication of a future time at which at least one of the set of requested states or the one or more requested parameter sets are requested to be applied.

In some examples, each requested state of the set of requested states indicates whether a corresponding operation mode of the set of operation modes is requested to be enabled or disabled. In some examples, each parameter set of the one or more requested parameter sets corresponds to a respective operation mode of the one or more operation modes.

In some examples, the one or more operation modes are each associated with a requested state of enabled.

In some examples, the set of operation modes includes at least one of a non-primary channel access mode, a dynamic sub-band operation mode, a dynamic bandwidth expansion mode, a dynamic power save mode, or a dynamic unavailability operation mode.

In some examples, different operation modes of the set of operation modes are associated with different parameter sets.

In some examples, the first frame is an action frame, a notification frame, an association request frame, or a reassociation request frame.

In some examples, the set of operation modes is associated with a generation of the STA. In some examples, the generation of the STA is associated with a UHR version of an IEEE 802.11 standard.

Additionally, or alternatively, the wireless communication device 1200 is configurable or configured to receive, from an access point (AP), a management frame that includes first information that indicates a set of current states associated with a set of operation modes and second information that indicates at least one future state associated with at least one operation mode of the set of operation modes. Additionally, or alternatively, the wireless communication device 1200 is configurable or configured to communicate one or more messages with the AP in accordance with the first information within a first time period and in accordance with the second information within a second time period subsequent to the first time period.

FIG. 13 shows a flowchart illustrating an example process 1300 performable by or at an AP that supports parameter updates for ultra-high reliability operation modes. The operations of the process 1300 may be implemented by an AP or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the AP may transmit, to one or more stations (STAs), a management frame that comprises first information that indicates a set of current states associated with a set of operation modes and second information that indicates at least one future state associated with at least one operation mode of the set of operation modes. The operations of 1305 may be performed in accordance with examples as disclosed herein. In some implementations, aspects of the operations of 1305 may be performed by a parameter update component 1125 as described with reference to FIG. 11.

In some examples, in 1310, the AP may communicate one or more messages with at least one STA of the one or more STAs in accordance with the first information within a first time period and in accordance with the second information within a second time period subsequent to the first time period. The operations of 1310 may be performed in accordance with examples as disclosed herein. In some implementations, aspects of the operations of 1310 may be performed by an operational mode component 1130 as described with reference to FIG. 11.

FIG. 14 shows a flowchart illustrating an example process 1400 performable by or at a STA that supports parameter updates for ultra-high reliability operation modes. The operations of the process 1400 may be implemented by a STA or its components as described herein. For example, the process 1400 may be performed by a wireless communication device, such as the wireless communication device 1200 described with reference to FIG. 12, operating as or within a wireless STA. In some examples, the process 1400 may be performed by a wireless STA, such as one of the STAs 104 described with reference to FIG. 1.

In some examples, in 1405, the STA may transmit, to an access point (AP), a first frame that comprises first information that indicates at least one requested state associated with at least one operation mode of a set of operation modes or indicates one or more requested parameter sets associated with one or more operation modes of the set of operation modes, or both. The operations of 1405 may be performed in accordance with examples as disclosed herein. In some implementations, aspects of the operations of 1405 may be performed by a parameter update request component 1225 as described with reference to FIG. 12.

In some examples, in 1410, the STA may receive, from the AP, a second frame that comprises second information that indicates at least one of an acceptance or a confirmation of the at least one requested state or the one or more requested parameter sets. The operations of 1410 may be performed in accordance with examples as disclosed herein. In some implementations, aspects of the operations of 1410 may be performed by a parameter update response component 1230 as described with reference to FIG. 12.

In some examples, in 1415, the STA may communicate one or more messages with the AP in accordance with at least one of the first information or the second information. The operations of 1415 may be performed in accordance with examples as disclosed herein. In some implementations, aspects of the operations of 1415 may be performed by an operational mode component 1235 as described with reference to FIG. 12.

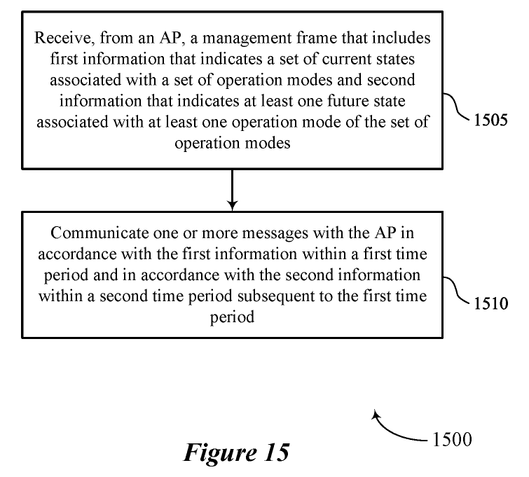

FIG. 15 shows a flowchart illustrating an example process 1500 performable by or at a STA that supports parameter updates for ultra-high reliability operation modes. The operations of the process 1500 may be implemented by a STA or its components as described herein. For example, the process 1500 may be performed by a wireless communication device, such as the wireless communication device 1200 described with reference to FIG. 12, operating as or within a wireless STA. In some examples, the process 1500 may be performed by a wireless STA, such as one of the STAs 104 described with reference to FIG. 1.

In some examples, in 1505, the STA may receive, from an access point (AP), a management frame that includes first information that indicates a set of current states associated with a set of operation modes and second information that indicates at least one future state associated with at least one operation mode of the set of operation modes. The operations of 1505 may be performed in accordance with examples as disclosed herein. In some implementations, aspects of the operations of 1505 may be performed by an operational mode component 1235 as described with reference to FIG. 12.

In some examples, in 1510, the STA may communicate one or more messages with the AP in accordance with the first information within a first time period and in accordance with the second information within a second time period subsequent to the first time period. The operations of 1510 may be performed in accordance with examples as disclosed herein. In some implementations, aspects of the operations of 1510 may be performed by an operational mode component 1235 as described with reference to FIG. 12.

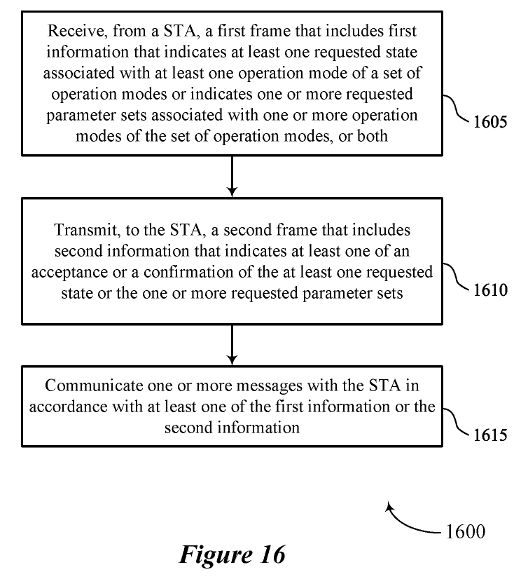

FIG. 16 shows a flowchart illustrating an example process 1600 performable by or at an AP that supports parameter updates for ultra-high reliability operation modes. The operations of the process 1600 may be implemented by an AP or its components as described herein. For example, the process 1600 may be performed by a wireless communication device, such as the wireless communication device 1100 described with reference to FIG. 11, operating as or within a wireless AP. In some examples, the process 1600 may be performed by a wireless AP, such as one of the APs 102 described with reference to FIG. 1.

In some examples, in 1605, the AP may receive, from a station (STA), a first frame that includes first information that indicates at least one requested state associated with at least one operation mode of a set of operation modes or indicates one or more requested parameter sets associated with one or more operation modes of the set of operation modes, or both. The operations of 1605 may be performed in accordance with examples as disclosed herein. In some implementations, aspects of the operations of 1605 may be performed by a parameter update component 1125 as described with reference to FIG. 11.

In some examples, in 1610, the AP may transmit, to the STA, a second frame that includes second information that indicates at least one of an acceptance or a confirmation of the at least one requested state or the one or more requested parameter sets. The operations of 1610 may be performed in accordance with examples as disclosed herein. In some implementations, aspects of the operations of 1610 may be performed by a parameter update component 1125 as described with reference to FIG. 11.

In some examples, in 1615, the AP may communicate one or more messages with the STA in accordance with at least one of the first information or the second information. The operations of 1615 may be performed in accordance with examples as disclosed herein. In some implementations, aspects of the operations of 1615 may be performed by an operational mode component 1130 as described with reference to FIG. 11.

Implementation examples are described in the following numbered clauses:

Clause 1: A method for wireless communication by an access point (AP), comprising: transmitting, to one or more stations (STAs), a management frame that comprises first information that indicates a set of current states associated with a set of operation modes and second information that indicates at least one future state associated with at least one operation mode of the set of operation modes; and communicating one or more messages with at least one STA of the one or more STAs in accordance with the first information within a first time period and in accordance with the second information within a second time period subsequent to the first time period.

Clause 2: The method of clause 1, wherein the first information further indicates one or more current parameter sets associated with one or more first operation modes of the set of operation modes, the second information further indicates one or more future parameter sets associated with one or more second operation modes of the set of operation modes, or both.

Clause 3: The method of any of clauses 1–2, wherein the management frame comprises the second information in accordance with at least one of a future state or a future parameter set associated with an operation mode of the set of operation modes being different from a current state or a current parameter set associated with the operation mode.

Clause 4: The method of clause 1, wherein, to communicate the one or more messages with the at least one STA, the AP communicates one or more first messages with the at least one STA in accordance with the set of current states associated with the set of operation modes and in accordance with one or more current parameter sets associated with one or more first operation modes of the set of operation modes within the first time period; and communicates one or more second messages with the at least one STA in accordance with the at least one future state associated with the at least one operation mode and in accordance with one or more future parameter sets associated with one or more second operation modes of the set of operation modes within the second time period subsequent to the first time period.

Clause 5: The method of any of clauses 1–4, wherein the first information is comprised within a first element of the management frame, and wherein the second information is comprised within a second element of the management frame.

Clause 6: The method of clause 5, wherein the first element comprises a first set of fields that indicates the set of current states associated with the set of operation modes.

Clause 7: The method of clause 5, wherein the second element comprises a first set of fields that indicates the at least one future state associated with the at least one operation mode, a second set of fields that indicates one or more future parameter sets associated with one or more second operation modes of the set of operation modes, or both. For example, if an operation mode goes from enabled to disabled, the second element may comprise the first set of fields but not the second set of fields. By way of further example, if an operation mode goes from disabled to enabled, the second element may comprise the first set of fields and the second set of fields.

Clause 8: The method of any of clauses 5–7, wherein the first element is a UHR operation element, and the second element is a parameter update element.

Clause 9: The method of any of clauses 1–8, wherein the second information comprises an indication of a future time at which the at least one future state and the one or more future parameter sets are to be applied.

Clause 10: The method of any of clauses 1–9, wherein different operation modes of the set of operation modes are associated with different parameter sets.

Clause 11: The method of any of clauses 1–10, wherein the set of operation modes comprises at least one of a non-primary channel access mode, a dynamic sub- band operation mode, a dynamic bandwidth expansion mode, an AP power save mode, or a high-priority enhanced distributed channel access mode.

Clause 12: The method of any of clauses 1–11, wherein the management frame comprises a beacon frame, a probe response frame, an action frame, an association response frame, or a reassociation response frame.

Clause 13: The method of any of clauses 1–12, wherein the first information and the second information are associated with a first link of the AP via which the management frame is transmitted, the management frame further comprises third information associated with a second link of the AP, and the third information indicates at least one second future state associated with at least one second operation mode of the set of operation modes and indicates one or more second future parameter sets associated with one or more third operation modes of the set of operation modes.

Clause 14: The method of clause 13, wherein the management frame comprises a frame body and a multi-link element, the frame body comprises the first information and the second information, and the multi-link element comprises the third information.

Clause 15: The method of clause 14, wherein the multi-link element comprises a per-STA profile subelement corresponding to the second link, the per-STA profile subelement comprises a STA profile field, and the STA profile field comprises an element that comprises the third information.

Clause 16: The method of any of clauses 14–15, wherein the element within the STA profile field that comprises the third information is a parameter update element.

Clause 17: The method of any of clauses 1–16, wherein each current state of the set of current states indicates whether a corresponding operation mode of the set of operation modes is enabled or disabled at a current time.

Clause 18: The method of any of clauses 1–17, wherein each future state of the at least one future state indicates whether a corresponding operation mode of the set of operation modes is enabled or disabled at a future time.

Clause 19: The method of any of clauses 1–18, wherein each current parameter set of the one or more current parameter sets corresponds to a respective operation mode of the one or more first operation modes.

Clause 20: The method of any of clauses 1–19, wherein each future parameter set of the one or more future parameter sets corresponds to a respective operation mode of the one or more second operation modes.

Clause 21: The method of any of clauses 1–20, wherein the one or more first operation modes are each associated with a current state of enabled.

Clause 22: The method of any of clauses 1–21, wherein the one or more second operation modes are each associated with a future state of enabled.

Clause 23: The method of any of clauses 1–22, wherein the at least one STA is associated with the AP.

Clause 24: The method of any of clauses 1–23, wherein the set of operation modes is associated with a generation of the AP.

Clause 25: The method of clause 24, wherein the generation of the AP is associated with an ultra-high reliability (UHR) version of an Institute of Electrical and Electronics Engineers (IEEE) 802.11 standard.

Clause 26: The method of any of clauses 1–25, wherein the first information indicates the set of current states and the second information indicates the at least one future state without requiring that parameters be present in a beacon frame.

Clause 27: The method of any of clauses 1–26, wherein the second element omits parameter values when indicating disablement of an operation mode and includes parameter values when indicating enablement or a parameter update of the operation mode.

Clause 28: The method of any of clauses 1–27, wherein the first element and the second element are parsable and interpretable by both APs and STAs.

Clause 29: The method of any of clauses 1–28, wherein the management frame is broadcast by the AP and is receivable by one or more STAs within a basic service set (BSS).

Clause 30: The method of any of clauses 1–29, wherein the first time period and the second time period are non-overlapping.

Clause 31: The method of any of clauses 1–30, wherein the second information is transmitted subsequent to the first information in time.

Clause 32: The method of any of clauses 1–31, wherein the first element and the second element are included in a same management frame or in different management frames.

Clause 33: A method for wireless communication by a station (STA), comprising: receiving, from an access point (AP), a management frame that comprises first information that indicates a set of current states associated with a set of operation modes and second information that indicates at least one future state associated with at least one operation mode of the set of operation modes; and communicating one or more messages with the AP in accordance with the first information within a first time period and in accordance with the second information within a second time period subsequent to the first time period.

Clause 34: The method of clause 33, wherein the first information further indicates one or more current parameter sets associated with one or more first operation modes of the set of operation modes, the second information further indicates one or more future parameter sets associated with one or more second operation modes of the set of operation modes, or both.

Clause 35: The method of any of clauses 33–34, wherein the management frame comprises the second information in accordance with at least one of a future state or a future parameter set associated with an operation mode of the set of operation modes being different from a current state or a current parameter set associated with the operation mode.

Clause 36: The method of clause 33, wherein, to communicate the one or more messages with the AP, the STA communicates one or more first messages with the AP in accordance with the set of current states associated with the set of operation modes and in accordance with one or more current parameter sets associated with one or more first operation modes of the set of operation modes within the first time period; and communicates one or more second messages with the AP in accordance with the at least one future state associated with the at least one operation mode and in accordance with one or more future parameter sets associated with one or more second operation modes of the set of operation modes within the second time period subsequent to the first time period.

Clause 37: The method of any of clauses 33–36, wherein the first information is comprised within a first element of the management frame, and wherein the second information is comprised within a second element of the management frame.

Clause 38: The method of clause 37, wherein the first element comprises a first set of fields that indicates the set of current states associated with the set of operation modes.

Clause 39: The method of clause 37, wherein the second element comprises a first set of fields that indicates the at least one future state associated with the at least one operation mode, a second set of fields that indicates one or more future parameter sets associated with one or more second operation modes of the set of operation modes, or both.

Clause 40: The method of any of clauses 37–39, wherein the first element is a UHR operation element, and the second element is a parameter update element.

Clause 41: The method of any of clauses 33–40, wherein the second information comprises an indication of a future time at which the at least one future state and the one or more future parameter sets are to be applied.

Clause 42: The method of any of clauses 33–41, wherein different operation modes of the set of operation modes are associated with different parameter sets.

Clause 43: The method of any of clauses 33–42, wherein the set of operation modes comprises at least one of a non-primary channel access mode, a dynamic sub-band operation mode, a dynamic bandwidth expansion mode, an AP power save mode, or a high-priority enhanced distributed channel access mode.

Clause 44: The method of any of clauses 33–43, wherein the management frame comprises a beacon frame, a probe response frame, an action frame, an association response frame, or a reassociation response frame.

Clause 45: The method of any of clauses 33–44, wherein the first information and the second information are associated with a first link via which the management frame is transmitted by the AP, the management frame further comprises third information associated with a second link of the AP, and the third information indicates at least one second future state associated with at least one second operation mode of the set of operation modes and indicates one or more second future parameter sets associated with one or more third operation modes of the set of operation modes.

Clause 46: The method of clause 45, wherein the management frame comprises a frame body and a multi-link element, the frame body comprises the first information and the second information, and the multi-link element comprises the third information.

Clause 47: The method of clause 46, wherein the multi-link element comprises a per-STA profile subelement corresponding to the second link, the per-STA profile subelement comprises a STA profile field, and the STA profile field comprises an element that comprises the third information.

Clause 48: The method of any of clauses 46–47, wherein the element within the STA profile field that comprises the third information is a parameter update element.

Clause 49: The method of any of clauses 33–48, wherein each current state of the set of current states indicates whether a corresponding operation mode of the set of operation modes is enabled or disabled at a current time.

Clause 50: The method of any of clauses 33–49, wherein each future state of the at least one future state indicates whether a corresponding operation mode of the set of operation modes is enabled or disabled at a future time.

Clause 51: The method of any of clauses 33–50, wherein each current parameter set of the one or more current parameter sets corresponds to a respective operation mode of the one or more first operation modes.

Clause 52: The method of any of clauses 33–51, wherein each future parameter set of the one or more future parameter sets corresponds to a respective operation mode of the one or more second operation modes.

Clause 53: The method of any of clauses 33–52, wherein the one or more first operation modes are each associated with a current state of enabled.

Clause 54: The method of any of clauses 33–53, wherein the one or more second operation modes are each associated with a future state of enabled.

Clause 55: The method of any of clauses 33–54, wherein the STA is associated with the AP.

Clause 56: The method of any of clauses 33–55, wherein the set of operation modes is associated with a generation of the AP.

Clause 57: The method of clause 56, wherein the generation of the AP is associated with an ultra-high reliability (UHR) version of an Institute of Electrical and Electronics Engineers (IEEE) 802.11 standard.

Clause 58: The method of any of clauses 33–57, wherein the first information indicates the set of current states and the second information indicates the at least one future state without requiring that parameters be present in a beacon frame.

Clause 59: The method of any of clauses 33–58, wherein the second element omits parameter values when indicating disablement of an operation mode and includes parameter values when indicating enablement or a parameter update of the operation mode.

Clause 60: The method of any of clauses 33–59, wherein the first element and the second element are parsable and interpretable by both APs and STAs.

Clause 61: The method of any of clauses 33–60, wherein the management frame is broadcast by the AP and is receivable by the STA within a basic service set (BSS).

Clause 62: The method of any of clauses 33–61, wherein the first time period and the second time period are non-overlapping.

Clause 63: The method of any of clauses 33–62, wherein the second information is received subsequent to the first information in time.

Clause 64: The method of any of clauses 33–63, wherein the first element and the second element are included in a same management frame or in different management frames.

Clause 65: A method for wireless communication by a station (STA), comprising: transmitting, to an access point (AP), a first frame that comprises first information that indicates at least one requested state associated with at least one operation mode of a set of operation modes or indicates one or more requested parameter sets associated with one or more operation modes of the set of operation modes, or both; receiving, from the AP, a second frame that comprises second information that indicates at least one of an acceptance or a confirmation of the at least one requested state or the one or more requested parameter sets; and communicating one or more messages with the AP in accordance with at least one of the first information or the second information. The at least one operation mode and the one or more operation modes may be the same operation mode(s), partially different sets of operation modes, or different operation modes.

Clause 66: The method of clause 65, wherein the second information further indicates a negotiation of at least one parameter set of the one or more requested parameter sets, wherein the negotiation comprises a proposal by the AP of at least one parameter value that differs from a parameter value of the at least one parameter set of the one or more requested parameter sets.

Clause 67: The method of any of clauses 65–66, wherein, to communicate the one or more messages with the AP, the STA communicates the one or more messages with the AP in accordance with the at least one of the acceptance or the confirmation of the at least one requested state or the one or more requested parameter sets.

Clause 68: The method of any of clauses 65–67, wherein the first information is comprised within an element of the first frame.

Clause 69: The method of clause 68, wherein the element comprises a first set of fields that indicates the at least one requested state associated with the at least one operation mode, and a second set of fields that indicates the one or more requested parameter sets associated with the one or more operation modes.

Clause 70: The method of any of clauses 65–69, wherein the second frame is received within a threshold amount of time relative to a transmission time of the first frame.

Clause 71: The method of any of clauses 65–70, wherein each requested state of the at least one requested state indicates whether a corresponding operation mode of the set of operation modes is requested to be enabled or disabled.

Clause 72: The method of any of clauses 65–71, wherein each parameter set of the one or more requested parameter sets corresponds to a respective operation mode of the one or more operation modes.

Clause 73: The method of any of clauses 65–72, wherein the one or more operation modes are each associated with a requested state of enabled.

Clause 74: The method of any of clauses 65–73, wherein the set of operation modes comprises at least one of a non-primary channel access mode, a dynamic sub-band operation mode, a dynamic bandwidth expansion mode, a dynamic power save mode, or a dynamic unavailability operation mode.

Clause 75: The method of any of clauses 65–74, wherein different operation modes of the set of operation modes are associated with different parameter sets.

Clause 76: The method of any of clauses 65–75, wherein the first frame is an action frame.

Clause 77: The method of any of clauses 65–76, wherein the set of operation modes is associated with a generation of the STA.

Clause 78: The method of clause 77, wherein the generation of the STA is associated with an ultra-high reliability (UHR) version of an Institute of Electrical and Electronics Engineers (IEEE) 802.11 standard.

Clause 79: A method for wireless communication by an access point (AP), comprising: receiving, from a station (STA), a first frame that comprises first information that indicates at least one requested state associated with at least one operation mode of a set of operation modes or indicates one or more requested parameter sets associated with one or more operation modes of the set of operation modes, or both; transmitting, to the STA, a second frame that comprises second information that indicates at least one of an acceptance or a confirmation of the at least one requested state or the one or more requested parameter sets; and communicating one or more messages with the STA in accordance with at least one of the first information or the second information. The at least one operation mode and the one or more operation modes may be the same operation mode(s), partially different sets of operation modes, or different operation modes.

Clause 80: The method of clause 79, wherein the second information further indicates a negotiation of at least one parameter set of the one or more requested parameter sets, wherein the negotiation comprises a proposal by the AP of at least one parameter value that differs from a parameter value of the at least one parameter set of the one or more requested parameter sets.

Clause 81: The method of any of clauses 79–80, wherein, to communicate the one or more messages with the STA, the AP communicates the one or more messages with the STA in accordance with the at least one of the acceptance or the confirmation of the at least one requested state or the one or more requested parameter sets.

Clause 82: The method of any of clauses 79–81, wherein the first information is comprised within an element of the first frame.

Clause 83: The method of clause 82, wherein the element comprises a first set of fields that indicates the at least one requested state associated with the at least one operation mode, and a second set of fields that indicates the one or more requested parameter sets associated with the one or more operation modes.

Clause 84: The method of any of clauses 79–83, wherein the second frame is transmitted within a threshold amount of time relative to a reception time of the first frame.

Clause 85: The method of any of clauses 79–84, wherein each requested state of the at least one requested state indicates whether a corresponding operation mode of the set of operation modes is requested to be enabled or disabled.

Clause 86: The method of any of clauses 79–85, wherein each parameter set of the one or more requested parameter sets corresponds to a respective operation mode of the one or more operation modes.

Clause 87: The method of any of clauses 79–86, wherein the one or more operation modes are each associated with a requested state of enabled.

Clause 88: The method of any of clauses 79–87, wherein the set of operation modes comprises at least one of a non-primary channel access mode, a dynamic sub-band operation mode, a dynamic bandwidth expansion mode, a dynamic power save mode, or a dynamic unavailability operation mode.

Clause 89: The method of any of clauses 79–88, wherein different operation modes of the set of operation modes are associated with different parameter sets.

Clause 90: The method of any of clauses 79–89, wherein the first frame is an action frame.

Clause 91: The method of any of clauses 79–90, wherein the set of operation modes is associated with a generation of the STA.

Clause 92: The method of clause 91, wherein the generation of the STA is associated with an ultra-high reliability (UHR) version of an Institute of Electrical and Electronics Engineers (IEEE) 802.11 standard.

Clause 93: An access point (AP) for wireless communication, including a processing system that includes processor circuitry and memory circuitry that stores code, the processing system configured to cause the AP to perform any of the methods of clauses 1–32 or 79–92.

Clause 94: A station (STA) for wireless communication, including a processing system that includes processor circuitry and memory circuitry that stores code, the processing system configured to cause the STA to perform any of the methods of clauses 33–78.

Clause 95: An AP for wireless communication, including at least one means for performing any of the methods of clauses 1–32 or 79–92.

Clause 96: A STA for wireless communication, including at least one means for performing any of the methods of clauses 33–78.

Clause 97: A non-transitory computer-readable medium storing code for wireless communication, the code including instructions executable by one or more processors to perform any of the methods of clauses 1–32 or 79–92.

Clause 98: A non-transitory computer-readable medium storing code for wireless communication, the code including instructions executable by one or more processors to perform any of the methods of clauses 33–78.

As used herein, the term “determine” or “determining” can encompass one or more of a wide variety of actions. For example, “determining” can include one or more of calculating, computing, processing, deriving, estimating, investigating, looking up, inferring, ascertaining, measuring, resolving, selecting, obtaining, choosing, identifying, interpreting, demodulating, decoding, reading, establishing, forming, or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, reading or otherwise obtaining some type of value, set, element or other information or result signaled in, for example, a received wireless packet, such as data or control signaling. In some other such examples, determining can involve a processor selecting or choosing one or more values, sets, elements or other information or results from a larger set of values, sets, elements or other information or results. In some other such examples, determining can involve a processor performing a measurement, such as on a received signal.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense, such as when referring to a series, and may be used interchangeably with the term “and/or,” unless otherwise explicitly indicated (such as if used in conjunction with “either” or “only one of”). For example, the term “a or b” as well as the term “a and/or b” may include “a” only, “b” only, or a combination of both “a” and “b.” Also, as used herein, the terms “has,” “have,” “having,” “comprise,” “comprising,” “include” and “including,” and derivatives thereof or similar terms are intended to be open-ended terms that do not limit an element that they modify (such as an element “having” a also may have b).

As used herein, the phrase “based on” is equivalent to “based at least in part on” and indicates a non-limiting relationship between elements “a” and “b.” In some aspects, a’ (which may be a variation or example of a) may be responsive to or in response to b’ (which may be a variation or example of b), such as if condition c is met. In some other aspects, a’’ (which may be a variation or example of at least one of a or a’) may be associated with b’’ (which may be a variation or example of at least one of b or b’). In some further aspects, a’’’ (which may be a variation or example of at least one of a or a’ or a’’) may be determined (or any of the other actions encompassed by usage of the word “determining” as described above) in accordance with b’’’ (which may be a variation or example of at least one of b or b’ or b’’). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous.

What is claimed is:

1. A station (STA), comprising:
a processing system that includes processor circuitry and memory circuitry that stores code, the processing system configured to cause the STA to:
transmit, to an access point (AP), a first frame that comprises first information that indicates at least one requested state associated with at least one operation mode of a set of operation modes or indicates one or more requested parameter sets associated with one or more operation modes of the set of operation modes, or both;
receive, from the AP, a second frame that comprises second information that indicates at least one of an acceptance or a confirmation of the at least one requested state or the one or more requested parameter sets; and
communicate one or more messages with the AP in accordance with at least one of the first information or the second information.

2. The STA of claim 1, wherein the second information further indicates a negotiation of at least one parameter set of the one or more requested parameter sets, wherein the negotiation comprises a proposal by the AP of at least one parameter value that differs from a parameter value of the at least one parameter set of the one or more requested parameter sets.

3. The STA of claim 1, wherein, to communicate the one or more messages with the AP, the processing system is configured to cause the STA to:
communicate the one or more messages with the AP in accordance with the at least one of the acceptance or the confirmation of the at least one requested state or the one or more requested parameter sets.

4. The STA of claim 1, wherein the first information is comprised within an element of the first frame.

5. The STA of claim 4, wherein the element comprises a first set of fields that indicates the at least one requested state associated with the at least one operation mode, and a second set of fields that indicates the one or more requested parameter sets associated with the one or more operation modes.

6. The STA of claim 1, wherein the second frame is received within a threshold amount of time relative to a transmission time of the first frame.

7. The STA of claim 1, wherein:
each requested state of the at least one requested state indicates whether a corresponding operation mode of the set of operation modes is requested to be enabled or disabled; and
each parameter set of the one or more requested parameter sets corresponds to a respective operation mode of the one or more operation modes.

8. The STA of claim 1, wherein the one or more operation modes are each associated with a requested state of enabled.

9. The STA of claim 1, wherein:
the set of operation modes comprises at least one of a non-primary channel access mode, a dynamic sub-band operation mode, a dynamic bandwidth expansion mode, a dynamic power save mode, or a dynamic unavailability operation mode.

10. The STA of claim 1, wherein:
different operation modes of the set of operation modes are associated with different parameter sets.

11. The STA of claim 1, wherein the first frame is an action frame.

12. The STA of claim 1, wherein:
the set of operation modes is associated with a generation of the STA, and
the generation of the STA is associated with an ultra-high reliability (UHR) version of an Institute of Electrical and Electronics Engineers (IEEE) 802.11 standard.

13. A method for wireless communication by a station (STA), comprising:
transmitting, to an access point (AP), a first frame that comprises first information that indicates at least one requested state associated with at least one operation mode of a set of operation modes or indicates one or more requested parameter sets associated with one or more operation modes of the set of operation modes, or both;
receiving, from the AP, a second frame that comprises second information that indicates at least one of an acceptance or a confirmation of the at least one requested state or the one or more requested parameter sets; and
communicating one or more messages with the AP in accordance with at least one of the first information or the second information.

14. The method of claim 13, wherein the first information indicates a set of requested states associated with the set of operation modes.

15. The method of claim 14, wherein:
each requested state of the set of requested states indicates whether a corresponding operation mode of the set of operation modes is requested to be enabled or disabled; and
each parameter set of the one or more requested parameter sets corresponds to a respective operation mode of the one or more operation modes.

16. The method of claim 13, wherein the first information is comprised within an element of the first frame, and wherein the element comprises:
a first set of fields that indicates the at least one requested state associated with the at least one operation mode, and
a second set of fields that indicates the one or more requested parameter sets associated with the one or more operation modes.

17. An access point (AP), comprising:
a processing system that includes processor circuitry and memory circuitry that stores code, the processing system configured to cause the AP to:
receive, from a station (STA), a first frame that comprises first information that indicates at least one requested state associated with at least one operation mode of a set of operation modes or indicates one or more requested parameter sets associated with one or more operation modes of the set of operation modes, or both;
transmit, to the STA, a second frame that comprises second information that indicates at least one of an acceptance or a confirmation of the at least one requested state or the one or more requested parameter sets; and
communicate one or more messages with the STA in accordance with at least one of the first information or the second information.

18. The AP of claim 17, wherein the second information further indicates a negotiation of at least one parameter set of the one or more requested parameter sets, wherein the negotiation comprises a proposal by the AP of at least one parameter value that differs from a parameter value of the at least one parameter set of the one or more requested parameter sets.

19. The AP of claim 17, wherein, to communicate the one or more messages with the STA, the processing system is configured to cause the AP to:
communicate the one or more messages with the STA in accordance with the at least one of the acceptance or the confirmation of the at least one requested state or the one or more requested parameter sets.

20. The AP of claim 17, wherein the first information is comprised within an element of the first frame, and wherein the element comprises:
a first set of fields that indicates the at least one requested state associated with the at least one operation mode, and
a second set of fields that indicates the one or more requested parameter sets associated with the one or more operation modes.
